(19) United States
(12) Patent Application Publication
(10) Pub. No.: US 2025/0177836 A1
(43) Pub. Date: Jun. 5, 2025

(54) METHOD AND APPARATUS FOR AUTO-SCORING A GOLF-BASED GAME

(71) Applicants: Timothy W. Markison, Mesa, AZ (US); Patricia M. Healy, Phoenix, AZ (US)

(72) Inventors: Timothy W. Markison, Mesa, AZ (US); Patricia M. Healy, Phoenix, AZ (US)

(21) Appl. No.: 19/043,010

(22) Filed: Jan. 31, 2025

Related U.S. Application Data
(63) Continuation of application No. 17/064,194, filed on Oct. 6, 2020.
(60) Provisional application No. 62/911,470, filed on Oct. 7, 2019.

(51) Int. Cl. A63B 71/06; A63B 67/02

(52) U.S. Cl. CPC A63B 71/0605; A63B 67/02; A63B 71/0669; A63B 71/0622; A63B 2071/0644; A63B 2071/0694

(57) ABSTRACT

A method includes determining whether a hit ball comes to rest on a grid. The method includes, when the hit ball does not come to rest on the grid, assigning zero points to the hit ball. When the hit ball comes to rest on the grid, the method includes determining whether the hit ball comes to rest within an accuracy zone of the grid and whether the hit ball comes to rest beyond a long drive marker of the grid. The method includes, when the hit ball does not come to rest within the accuracy zone and does not come to rest beyond the long drive marker, assigning a first number of points. The method includes, when the hit ball does not come to rest within the accuracy zone and comes to rest beyond the long drive marker, assigning a second number of points. The method includes, when the hit ball comes to rest within the accuracy zone and does not come to rest beyond the long drive marker, assigning the second or a different number of points. The method includes, when the hit ball comes to rest within the accuracy zone and comes to rest beyond the long drive marker, assigning a third number of points.

### CROSS-REFERENCE TO RELATED APPLICATIONS

The present U.S. Utility patent application claims priority pursuant to 35 U.S.C. § 120 as a continuation of U.S. Utility application Ser. No. 17/064,194, entitled “METHOD AND APPARATUS FOR AUTO-SCORING A GOLF-BASED GAME”, filed Oct. 6, 2020, which claims priority pursuant to 35 U.S.C. § 119 (e) to U.S. Provisional Application No. 62/911,470, entitled “METHOD AND APPARATUS FOR A GOLF-BASED GAME,” filed Oct. 7, 2019, each of which is hereby incorporated herein by reference in its entirety and made part of the present U.S. Utility patent application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to computer networks and more particularly to use of computer networks for a new golf-based game.

### Description of Related Art

The game of golf is known and is played at multiple levels; ranging from amateur youth leagues to professional associations. To emulate the play of golf and/or to practice golf; golf simulators have been created. In general, a golf simulator is a device that allows a golfer to hit a golf ball at a screen and the device measures a variety of data regarding the swing and contact with the ball. From the measured data, the golf simulator calculates one or more of distance, trajectory, ball speed, apex, ball rotation, ball fade, ball draw, etc. The calculated values and a simulated ball flight are projected on a screen.

New games have evolved from the classic game of golf. For example, there are amateur and professional long drive competitions, where players are given a certain number of balls to hit and the player hitting a ball the furthest wins. As another example, Top Golf™ provides a plurality of targets on a playing area. Players hit golf balls with trackers at the targets and points are accumulated based on the proximity to the targets. As yet another example, putting courses have been created, allowing players to compete at putting.

### BRIEF DESCRIPTION OF THE SEVERAL VIEWS OF THE DRAWING(S)

FIG. 1 is a schematic block diagram of an embodiment of a computing device network in accordance with the present invention;

FIG. 1A is a schematic block diagram of another embodiment of a computing device network in accordance with the present invention;

FIGS. 2A-2D are schematic block diagrams of embodiments of a computing device in accordance with the present invention;

FIGS. 3A-3E are schematic block diagrams of embodiments of a computing entity in accordance with the present invention;

FIG. 4A is a schematic block diagram of an embodiment of a game computing entity in accordance with the present invention;

FIG. 4B is a schematic block diagram of another embodiment of a game computing entity in accordance with the present invention;

FIG. 4C is a schematic block diagram of an example of a plurality game computing entities and a game scoring computing entity competing in a 5 Drive Golf™ game in accordance with the present invention;

FIG. 4D is a schematic block diagram of an example of a plurality game computing entities competing in a 5 Drive Golf™ game in accordance with the present invention;

FIGS. 5A-5O are diagram of examples of 5 Drive Golf™ grids in accordance with the present invention;

FIGS. 6A-6D are logic diagram of examples of setting up a 5 Drive Golf™ game in accordance with the present invention;

FIGS. 7A-7E are logic diagram of examples of creating a plurality of 5 Drive Golf™ grid for various player's distance and/or skill levels in accordance with the present invention;

FIGS. 7F-7G are diagram of examples of a plurality of 5 Drive Golf™ grid for various player's distance and/or skill levels in accordance with the present invention;

FIGS. 8A-8S are logic diagram of examples of scoring a 5 Drive Golf™ game in accordance with the present invention;

FIG. 9 is a schematic block diagram of an embodiment of team computing devices communicating with a game computing device in accordance with the present invention;

FIG. 10 is a logic diagram of an example of a method for tracking a round of 5 Drive Golf™ in accordance with the present invention;

FIG. 11 is a logic diagram of an example of a method for establishing head-to-head competition for a game of 5 Drive Golf™ in accordance with the present invention;

FIG. 12 is a logic diagram of an example of a method for establishing a team's line up based on a number of players competing in a game of 5 Drive Golf™ in accordance with the present invention;

FIG. 13 is a logic diagram of an example of a method for updating a team's score based on a round of 5 Drive Golf™ in accordance with the present invention;

FIG. 14 is a logic diagram of an example of a method for determining per ball points in a round of 5 Drive Golf™ in accordance with the present invention;

FIG. 15 is a logic diagram of an example of a method for determining bonus points for a round of 5 Drive Golf™ in accordance with the present invention;

FIGS. 16-19 are diagrams of an example of a 5 Drive Golf™ score card in accordance with the present invention;

FIG. 20 is a diagram of another example of a 5 Drive Golf™ game score in accordance with the present invention;

FIG. 21 is a logic diagram of an example of a method for processing a tie-breaker for a game of 5 Drive Golf™ in accordance with the present invention;

FIG. 22 is a logic diagram of an example of a method for determining a winning team for a game of 5 Drive Golf™ and updating league standings in accordance with the present invention;

FIG. 23 is a diagram of an example of a 5 Drive Golf™ league's standings in accordance with the present invention;

FIGS. 24-26 are a logic diagram of an example of a method for determining playoff teams for 5 Drive Golf™ League in accordance with the present invention;

FIG. 27 is a diagram of an example of updating a player's statistics in accordance with the present invention;

FIG. 28 is a diagram of an example of creating a 5 Drive Golf™ League in accordance with the present invention;

FIG. 29 is a diagram of an example of a recreational organization computing entity registering a season of a 5 Drive Golf™ League with a national organization computing entity in accordance with the present invention;

FIG. 30 is a diagram of an example of a player computing entity registering a player with a national organization computing entity in accordance with the present invention;

FIG. 31 is a diagram of an example of a team computing entity registering a team with a national organization computing entity and joining a 5 Drive Golf™ League in accordance with the present invention;

FIG. 32 is a diagram of an example of a national organization computing entity creating a recreational organization data record in accordance with the present invention; and

FIG. 33 is a diagram of an example of a national organization computing entity registering teams and players for a season of a 5 Drive Golf™ League in accordance with the present invention.

### DETAILED DESCRIPTION OF THE INVENTION

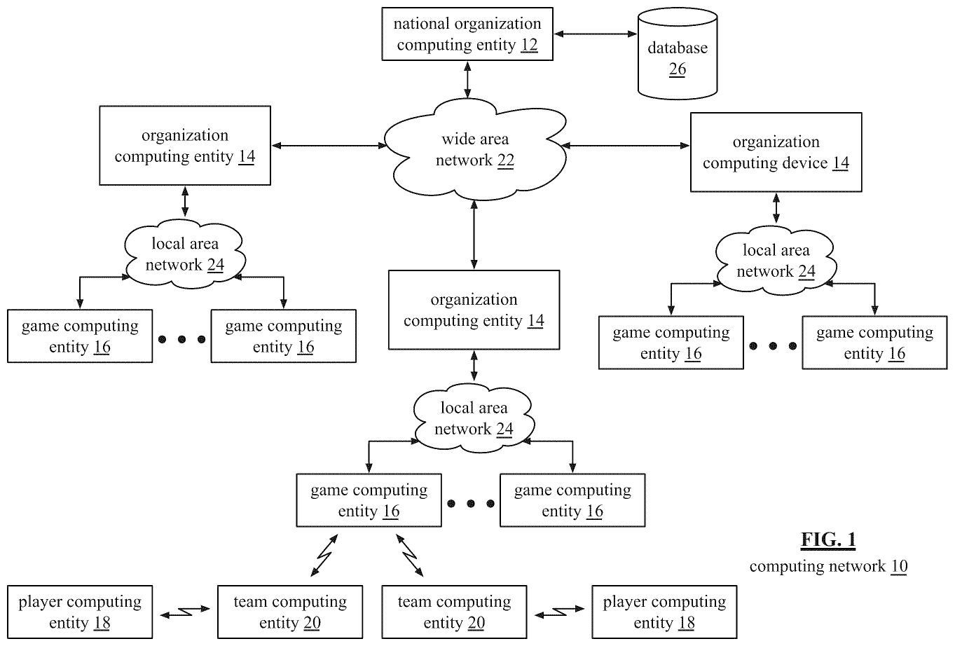

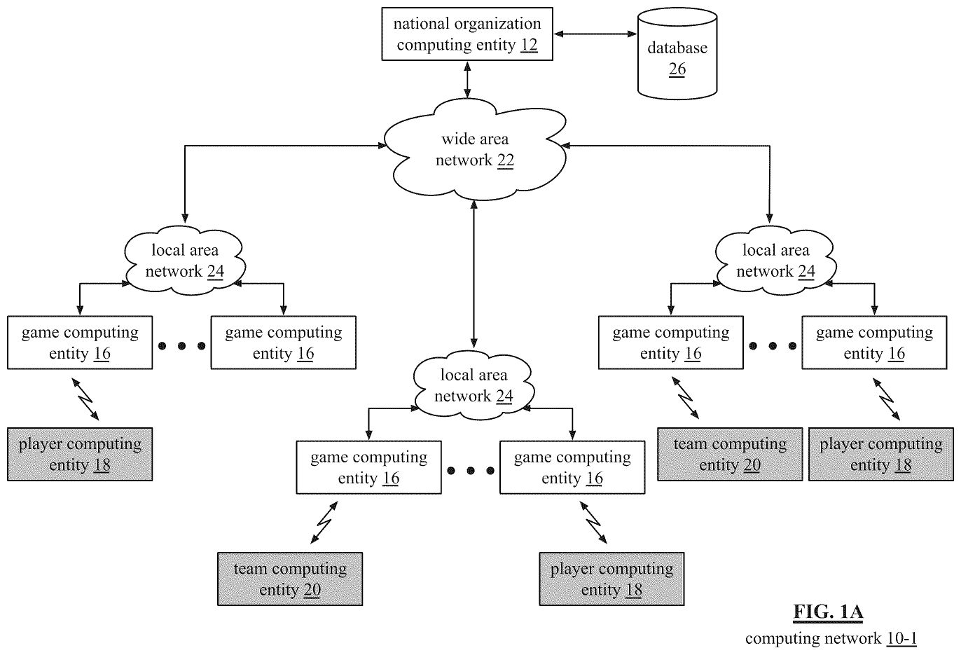

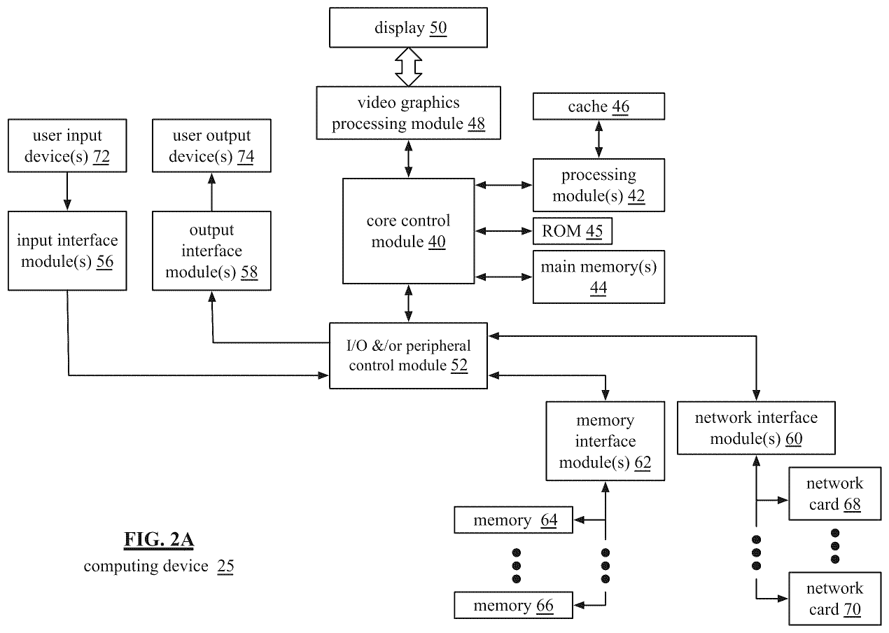

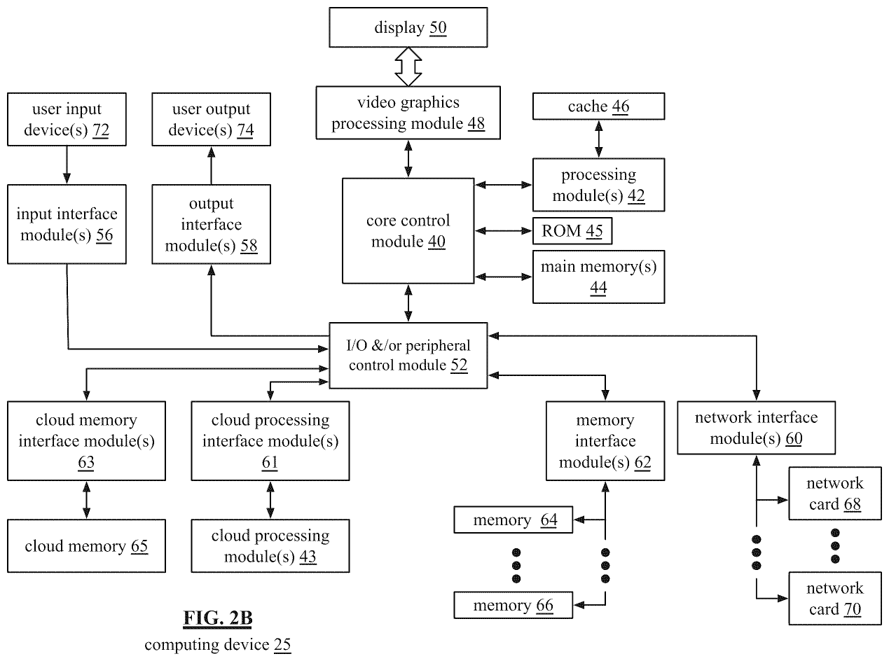

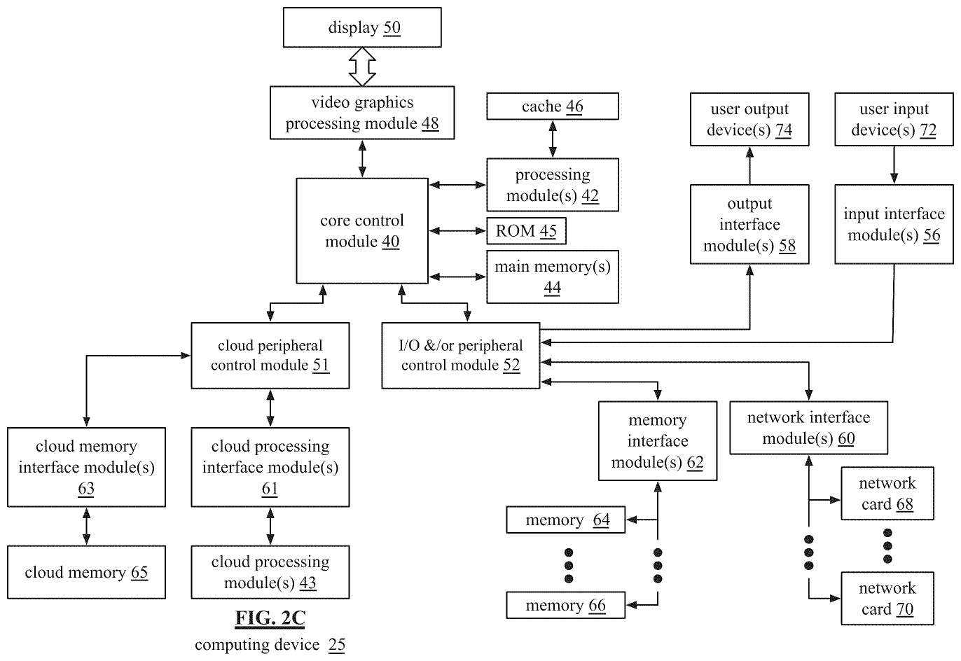

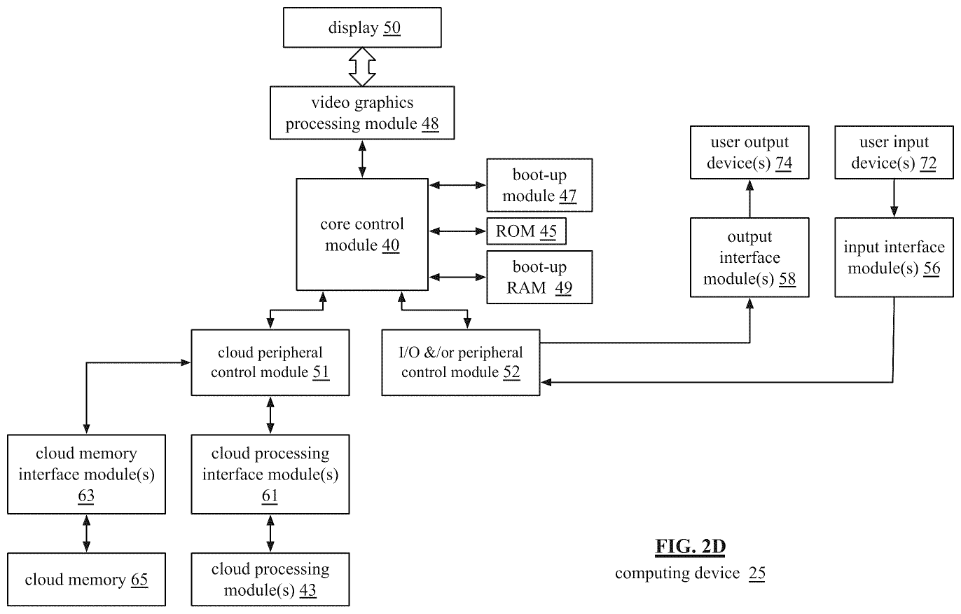

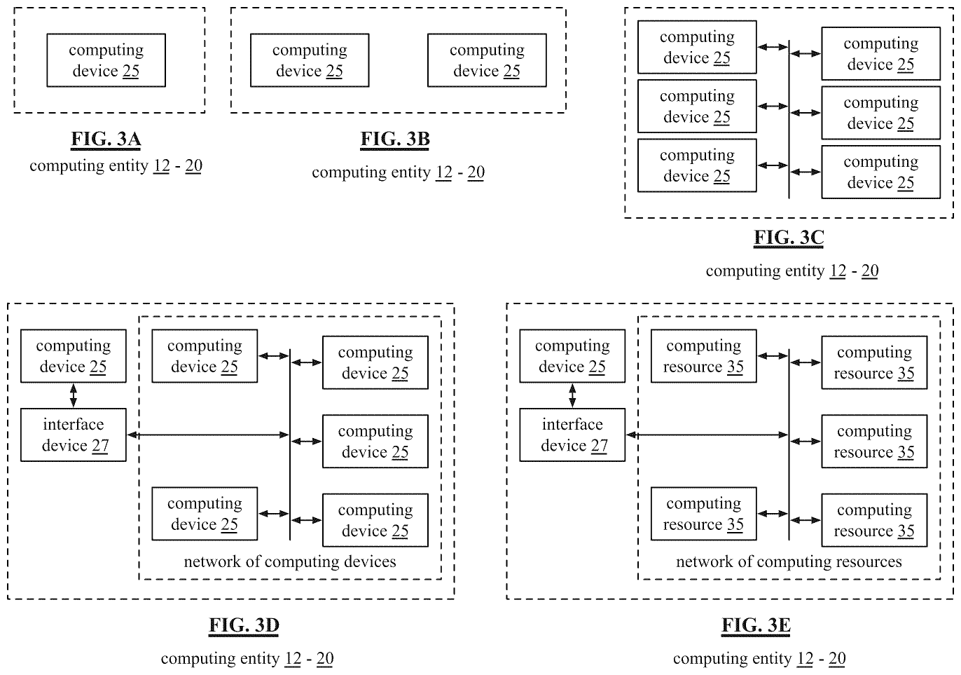

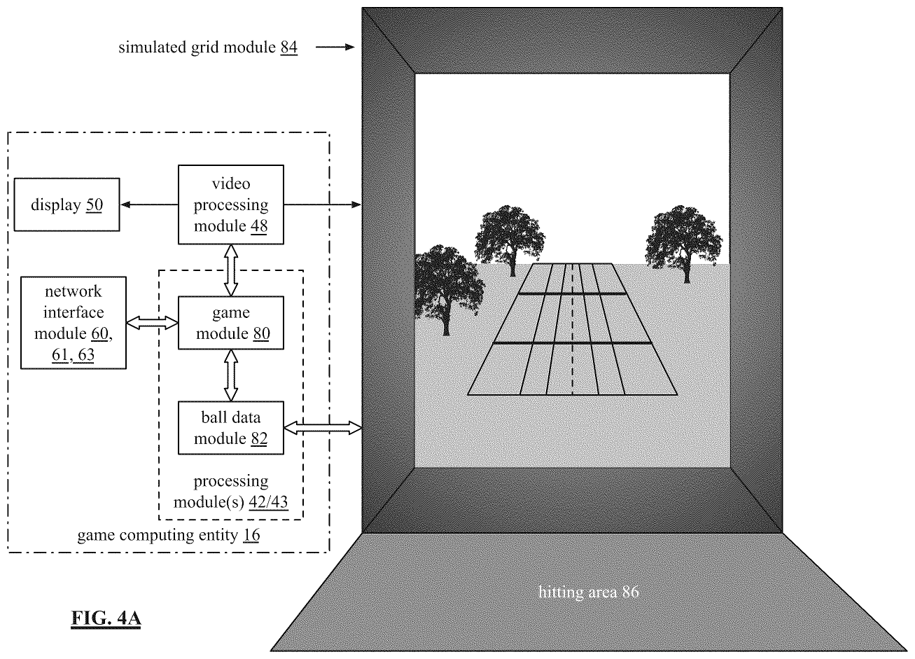

FIG. 1 is a schematic block diagram of an embodiment of a computing network 10 that includes a national organization computing entity 12, one or more organization computing entities 14, a plurality of game computing entities 16, a plurality of player computing entities 18, a plurality of team computing entities 20, one or more wide area networks 22, one or more local area networks 24, and one or more databases 26. Each of the computing entities includes one or more computing devices as described in reference to FIGS. 2A-2D and FIGS. 3A-3D.

The computing network 10 supports the play of a golf based game called Five Drive Golf, which can be played in a player-versus-player format, a team-versus-team format, an open player format, and/or an open team format. A game includes a number of rounds and, in each round, a player (or team) hits a certain number of balls per round. For example, a game includes five rounds and each player (or team) hits five ball per round.

In play, a player hits a golf ball at a grid, which is a minimum distance from the player and has a width. If the hit ball comes to rest within the grid, the player is awarded one or more points in accordance with a point system. The grid may include one or more of a long drive marker, a super long drive marker, an accurate zone, and a super accurate zone. If the hit ball comes to rest in the accurate zone or in the super accurate zone and/or comes to rest beyond the long drive marker or the super long drive marker, additional points are awarded per the point system.

After each player (or team) has hit the requisite number of balls in a round, bonus points may be awarded if all of the hit balls come to rest on the grid. For example, five bonus points are awarded if all of the hit balls are anywhere on the grid. As another example, ten bonus points are awarded if all of the hit balls are within the accuracy zone or all of the hit balls are beyond the long drive marker. As yet another example, fifteen bonus points are awarded if all of the hit balls are within the accuracy zone and are beyond the long drive marker.

Once all of the rounds of a game have been played, each player's (or team's) points are totaled. The player (or team) with the most points wins. If two or more players (or teams) end the game with the same number of total points, a tie breaker is played.

The point system and the bonus structure can be set to treat driving distance substantially equal to driving accuracy. Alternatively, the point system and the bonus structure can be set to favor driving distance and/or driving accuracy to provide different competitive focus to a Five Drive Golf Game (or 5Drive).

To allow players of different abilities and skills to fairly compete, the grid can be scaled. For example, an equation is used to insure that the a ratio between minimum distance and grid width is similar as the grid is to scaled based on distance ability. As another example, another equation is used to scale the grid based on skill level.

While it is contemplated that most players will use a driver when playing 5Drive, a player could use another club. Regardless of the club selection, 5Drive provides a new sport that weighs driving distance similarly (or dissimilarly if desired) to driving accuracy, which allows players to compete in a game while also honing their skills for regular golf.

In an embodiment, each player is associated with a player computing entity 18. Via the player computing entity 18, the associated player registers with a national organization via the national organization computing entity 12. The national organization computing entity 12 assigns the player a unique 5Drive ID (identifier) and records personal data of the player in the database 26. The personal data includes public data and private data. The private data includes billing information, IP address, photo, age, address, email address, birthdate, the player's 5Drive ID, payment information, etc. The public data includes the player's statistics, the teams on which the player has played and/or is playing with, etc.

Once a player is registered with the national organization, the player may commence playing 5Drive. The player may play individually and/or on a team. Whether playing individually or on a team, the player can play in head-to-head games or in an open format. For example, a player chooses to play another player in a one-on-one game. As another example, the player chooses to play a game against a plurality of other players in an open game format. As yet another example, the player has joined a team that competes in team-on-team games. As a further example, the player has joined a team that competes in a game against a plurality of teams in an open team format.

To play in a game as an individual, a player registers with a game computing entity 16 that supports 5Drive game play. The game computing entity 16 verifies the player's registration information (e.g., 5Drive player ID, etc.) with the national organization and, if verified, sets up a grid for game based on the player's driving distance ability and/or accuracy skills. Alternatively the player may select the grid for the game. Once the grid is set up and the grid is (or grids are) set up for another player (or players), the game computing entity 16 executes a series of functions to support the play of 5Drive.

To play in a game on a team, a team computing entity 20 registers with the game computing device. Note that prior to the game, the player affiliated with the team via the player's computing entity 18 and the team computing entity 20. Further note that prior to the game, the team registered with the national organization via the national organization computing entity 12. The national organization computing entity 12 assigns the team a unique 5Drive Team ID (identifier) and records personal data of the team in the database 26. The personal data includes public data and private data. The private data includes billing information, IP address, photo, age, address, email address, birthdate, the player's 5Drive ID, payment information, team player personal information (or a link thereto), etc. The public data includes the team statistics, league standings, player's statistics, the leagues in which the team has played and/or is playing in, etc.

The game computing entity 16 verifies the team's registration information (e.g., 5Drive Team ID, etc.) and each of its players' information (e.g., 5Drive player IDs, etc.) with the national organization and, if verified, sets up one or more grids for game based each player's driving distance ability and/or accuracy skills. Alternatively, one or more players may select their grid for the game. Once the grid is (or grids) set up and the grid is (or grids are) set up for another team (or teams), the game computing entity 16 executes a series of functions to support the play of 5Drive.

If the team play is part of a league, an organization (e.g., professional and/or recreational) affiliated with organization computing entity 14 registered the league with the national organization via the national organization computing entity 12. The national organization computing entity 12 assigns the organization a unique 5Drive Organization ID (identifier) and records personal data of the organization in the database 26. The personal data includes public data and private data. The private data includes billing information, IP address, photo, age, address, email address, birthdate, the player's 5Drive ID, payment information, team player personal information (or a link thereto), etc. The public data includes the team statistics, league standings, player's statistics, the leagues in which the team has played and/or is playing in, etc.

In addition to receiving a unique 5Drive Organization ID, an organization receives a unique 5Drive League ID (one for each league it hosts). For a league hosted by an organization, the national organization computing entity 12 stores information regarding the league in the database 26. For example, the national organization computing entity stores the teams in the leagues, team players' information (or links thereto), league standings, a league schedule, team statistics (or links thereto), player statistics (or links thereto), playoff schedule, playoff standings, etc.

FIG. 1A is a schematic block diagram of another embodiment of a computing network 10-1 is similar to the computing network of FIG. 1 with the exception that this network does not include organization computing entities. In this embodiment, the national organization computing entity 12 hosts leagues, hosts individual play, hosts open individual play, and/or host open team play.

In this network 10-1 and in the network 10 of FIG. 1, the players in a game (individual, team, open) may be at different sites. For example, three players are competing in an open individual game against each other. Each player's computing entity 18 (e.g., the blue shaded boxes) is associated with a corresponding game computing entity 16 at different sites (e.g., San Diego CA, Rochester NY, Jacksonville FL). Via the networks 22 and/or 24, the game computing entities 16 execute the functions of 5Drive to support a game between the three players.

As another example, two teams are competing from different sites. In this example, the team computing entities 20 (e.g., green shaded boxes) are affiliated with game computing entities 16. Note that the players of a team may be at the same site or at different sites using different game computing entities.

FIG. 2A is a schematic block diagram of an embodiment of a computing device 25 that includes a plurality of computing resources. The computing resources include a core control module 40, one or more processing modules 42, one or more main memories 44, a read only memory (ROM) 45 for a boot up sequence, cache memory 46, a video graphics processing module 48, a display 50 (optional), an Input-Output (I/O) peripheral control module 52, one or more input interface modules 56, one or more output interface modules 58, one or more network interface modules 60, and one or more memory interface modules 62. A processing module 42 is described in greater detail at the end of the detailed description of the invention section and, in an alternative embodiment, has a direction connection to the main memory 44. In an alternate embodiment, the core control module 40 and the I/O and/or peripheral control module 52 are one module, such as a chipset, a quick path interconnect (QPI), and/or an ultra-path interconnect (UPI).

Each of the main memories 44 includes one or more Random Access Memory (RAM) integrated circuits, or chips. For example, a main memory 44 includes four DDR4 (4th generation of double data rate) RAM chips, each running at a rate of 2,400 MHz. In general, the main memory 44 stores data and operational instructions most relevant for the processing module 42. For example, the core control module 40 coordinates the transfer of data and/or operational instructions from the main memory 44 and the memory 64-66. The data and/or operational instructions retrieve from memory 64-66 are the data and/or operational instructions requested by the processing module or will most likely be needed by the processing module. When the processing module is done with the data and/or operational instructions in main memory, the core control module 40 coordinates sending updated data to the memory 64-66 for storage.

The memory 64-66 includes one or more hard drives, one or more solid state memory chips, and/or one or more other large capacity storage devices that, in comparison to cache memory and main memory devices, is/are relatively inexpensive with respect to cost per amount of data stored. The memory 64-66 is coupled to the core control module 40 via the I/O and/or peripheral control module 52 and via one or more memory interface modules 62. In an embodiment, the I/O and/or peripheral control module 52 includes one or more Peripheral Component Interface (PCI) buses to which peripheral components connect to the core control module 40. A memory interface module 62 includes a software driver and a hardware connector for coupling a memory device to the I/O and/or peripheral control module 52. For example, a memory interface 62 is in accordance with a Serial Advanced Technology Attachment (SATA) port.

The core control module 40 coordinates data communications between the processing module(s) 42 and the network(s) 26 via the I/O and/or peripheral control module 52, the network interface module(s) 60, and a network card 68 or 70. A network card 68 or 70 includes a wireless communication unit or a wired communication unit. A wireless communication unit includes a wireless local area network (WLAN) communication device, a cellular communication device, a Bluetooth device, and/or a ZigBee communication device. A wired communication unit includes a Gigabit LAN connection, a Firewire connection, and/or a proprietary computer wired connection. A network interface module 60 includes a software driver and a hardware connector for coupling the network card to the I/O and/or peripheral control module 52. For example, the network interface module 60 is in accordance with one or more versions of IEEE 802.11, cellular telephone protocols, 10/100/1000 Gigabit LAN protocols, etc.

The core control module 40 coordinates data communications between the processing module(s) 42 and input device(s) 72 via the input interface module(s) 56 and the I/O and/or peripheral control module 52. An input device 72 includes a keypad, a keyboard, control switches, a touchpad, a microphone, a camera, etc. An input interface module 56 includes a software driver and a hardware connector for coupling an input device to the I/O and/or peripheral control module 52. In an embodiment, an input interface module 56 is in accordance with one or more Universal Serial Bus (USB) protocols.

The core control module 40 coordinates data communications between the processing module(s) 42 and output device(s) 74 via the output interface module(s) 58 and the I/O and/or peripheral control module 52. An output device 74 includes a speaker, auxiliary memory, headphones, etc. An output interface module 58 includes a software driver and a hardware connector for coupling an output device to the I/O and/or peripheral control module 52. In an embodiment, an output interface module 56 is in accordance with one or more audio codec protocols.

The processing module 42 communicates directly with a video graphics processing module 48 to display data on the display 50. The display 50 includes an LED (light emitting diode) display, an LCD (liquid crystal display), and/or other type of display technology. The display has a resolution, an aspect ratio, and other features that affect the quality of the display. The video graphics processing module 48 receives data from the processing module 42, processes the data to produce rendered data in accordance with the characteristics of the display, and provides the rendered data to the display 50.

FIG. 2B is a schematic block diagram of an embodiment of a computing device 25 that includes a plurality of computing resources similar to the computing resources of FIG. 2A with the addition of one or more cloud memory interface modules 63, one or more cloud processing interface modules 61, cloud memory 65, and one or more cloud processing modules 43. The cloud memory 65 includes one or more tiers of memory (e.g., ROM, volatile (RAM, main, etc.), non-volatile (hard drive, solid-state, etc.) and/or backup (hard drive, tape, etc.)) that is remoted from the core control module and is accessed via a network (WAN and/or LAN). The cloud processing module 43 is similar to processing module 43 but is remoted from the core control module and is accessed via a network.

FIG. 2C is a schematic block diagram of an embodiment of a computing device 25 that includes a plurality of computing resources similar to the computing resources of FIG. 2B with a change in how the cloud memory interface module(s) 63 and the cloud processing interface module(s) 62 are coupled to the core control module 40. In this embodiment, the interface modules 61 and 63 are coupled to a cloud peripheral control module 51 that directly couples to the core control module 40.

FIG. 2D is a schematic block diagram of an embodiment of a computing device 25 that includes a plurality of computing resources, which includes include a core control module 40, a boot up module 47, boot up RAM 49, a read only memory (ROM) 45, a video graphics processing module 48, a display 50 (optional), an Input-Output (I/O) peripheral control module 52, one or more input interface modules 56, one or more output interface modules 58, one or more cloud memory interface modules 63, one or more cloud processing interface modules 62, cloud memory 65, and cloud processing module(s) 43.

In this embodiment, the computing device 25 includes enough processing resources (e.g., module 47, ROM 45, and RAM 49) to boot up. Once booted up, the cloud memory 65 and the cloud processing module(s) 43 function as the computing device's memory (e.g., main and hard drive) and processing module.

FIG. 3A is schematic block diagram of an embodiment of a computing entity 12-20 that includes a computing device 25 (e.g., one of the embodiments of FIGS. 2A-2D). A computing device may function as a user computing device, a server, a system computing device, a data storage device, a data security device, a networking device, a user access device, a cell phone, a tablet, a laptop, a printer, a game console, a satellite control box, a cable box, etc.

FIG. 3B is schematic block diagram of an embodiment of a computing entity 12-20 that includes two or more computing devices 25 (e.g., two or more from any combination of the embodiments of FIGS. 2A-2D). The computing devices 25 perform the functions of a computing entity in a peer processing manner (e.g., coordinate together to perform the functions), in a master-slave manner (e.g., one computing device coordinates and the other supports it), and/or in another manner.

FIG. 3C is schematic block diagram of an embodiment of a computing entity 12-20 that includes a network of computing devices 25 (e.g., two or more from any combination of the embodiments of FIGS. 2A-2D). The computing devices are coupled together via one or more network connections (e.g., WAN, LAN, cellular data, WLAN, etc.) and perform the functions of the computing entity.

FIG. 3D is schematic block diagram of an embodiment of a computing entity 12-20 that includes a primary computing device (e.g., any one of the computing devices of FIGS. 2A-2D), an interface device 27 (e.g., a network connection), and a network of computing devices 25 (e.g., one or more from any combination of the embodiments of FIGS. 2A-2D). The primary computing device utilizes the other computing devices as co-processors to execute one or more the functions of the computing entity, as storage for data, for other data processing functions, and/or storage purposes.

FIG. 3E is schematic block diagram of an embodiment of a computing entity 12-20 that includes a primary computing device (e.g., any one of the computing devices of FIGS. 2A-2D), an interface device 27 (e.g., a network connection), and a network of computing resources 35 (e.g., two or more resources from any combination of the embodiments of FIGS. 2A-2D). The primary computing device utilizes the computing resources as co-processors to execute one or more the functions of the computing entity, as storage for data, for other data processing functions, and/or storage purposes.

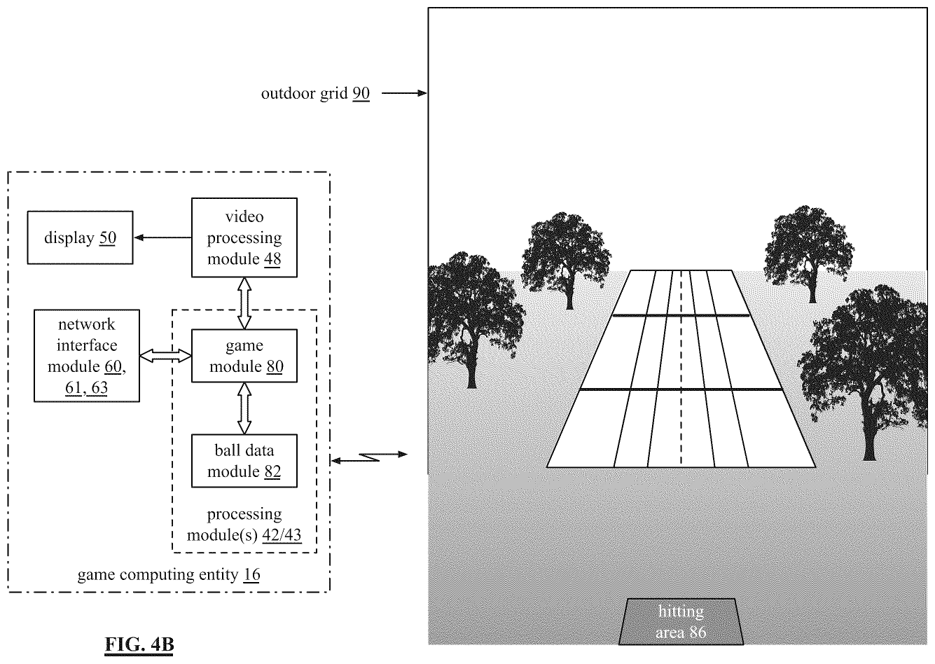

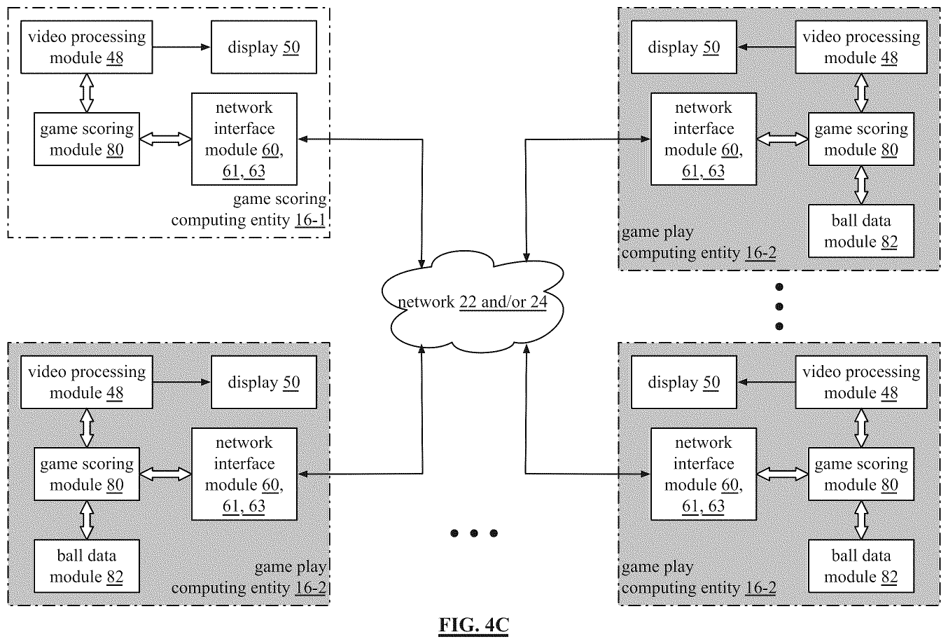

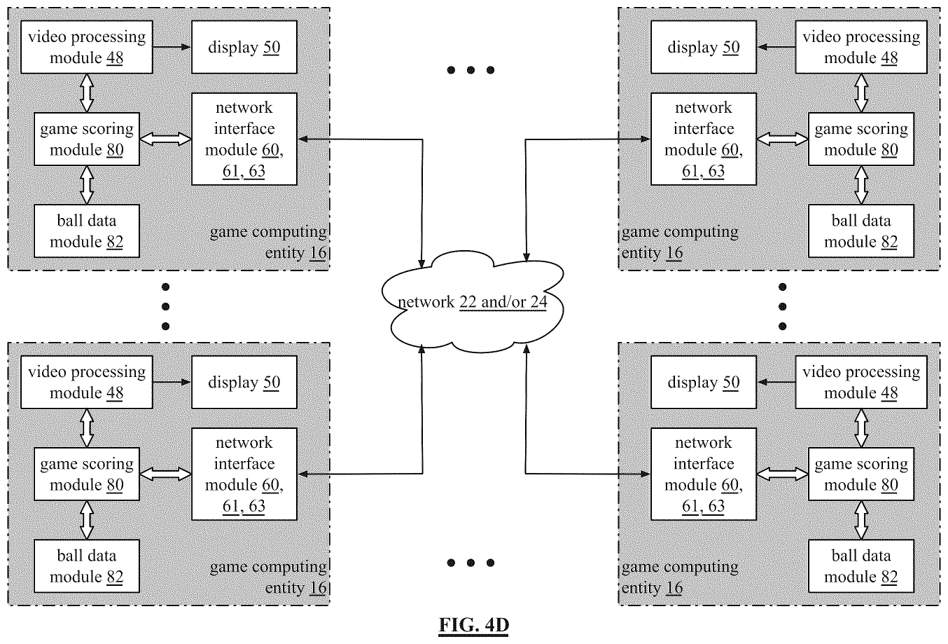

FIG. 4A is a schematic block diagram of an embodiment of a game computing entity 16 that includes one or more computing devices and/or a plurality of computing resources coupled to a simulated grid module 84 and associated hitting area 86. Of the one or more computing devices and/or computing resources, only a processing module 42 and/or 43, the video processing module 48, a display 50, and a network interface module 60, 61, and/or 63 are shown, The processing module is configured to include a ball data module 82 and a game module 80.

The simulated grid module 84 provides a video image of a grid based on grid parameters (e.g., minimum distance, grid width, long drive marker, super long drive marker, accurate zone width, and/or super accurate zone width) provided by the game module 80. The simulated grid module 84 also provides a simulated video of the flight of a golf ball after it is hit into a screen of the simulated grid module 84. To produce the simulated video, the simulated grid module 84 includes a device that measures spin, exit velocity, launch angle, club head speed, and/or other values regarding the impact between the club head and the golf ball and, based on the measurements, calculates the flight path of the golf ball, it's landing spot, and it's resting spot.

The game module 80 executes one or more of the methods described herein to set up a game, score a game, upload game results, and/or other 5Drive related functions. Once a game is set up, the ball data module 82 receives data from the simulated grid module 84 regarding the calculated flight path, landing spot, and resting spot of the golf ball. For a hit ball, the ball data module 82 determines whether the ball is on grid or not and, if on grid, the region of the grid (e.g., in long drive and accurate zone).

For each ball hit, the ball data module 82 provides the on grid, off grid determination to the game module 80. The game module 80 calculates a score based on the on grid, off grid determination. The game module 80 also keeps track of the number of balls hit, the number of rounds played, determines round bonuses, tabulates the final score, and may upload the game data to the national organization computing entity 12 or other organization computing entity.

In an alternate embodiment, the ball data module 82 is implemented within the simulate grid module 84. In another alternate embodiment, the ball data module 82 includes the device that measures spin, exit velocity, launch angle, club head speed, and/or other values regarding the impact between the club head and the golf ball and, based on the measurements, calculates the flight path of the golf ball, it's landing spot, and it's resting spot.

FIG. 4B is a schematic block diagram of another embodiment of a game computing entity 16, which is similar to the embodiment of the game computing entity of FIG. 4A. In this embodiment, however, the grid 90 is outdoors and the ball data module 82 includes the device that measures spin, exit velocity, launch angle, club head speed, and/or other values regarding the impact between the club head and the golf ball and, based on the measurements, calculates the flight path of the golf ball, it's landing spot, and it's resting spot (e.g., ball raw data). Alternatively, the ball data module 82 receives the ball raw data from a launch monitor.

FIG. 4C is a schematic block diagram of an example of a plurality game play computing entities 16-2 and a game scoring computing entity 16-1 supporting play of a 5 Drive Golf™ game. The game scoring module 80 of the game scoring computing entity 16-1 coordinates with the game scoring modules 80 of the game play computing entities 16-2 to set up a game, to play the game, and to record the results of the game.

For example, for a team versus team game, the game play computing entities 16-2 communicate with the game scoring computing entity 16-1 to indicate the player(s) and their team affiliation registered with them. For example, in a 2-player versus 2-player team game, player 1 of team 1 is registered with a first one of the game play computing entities; player 2 of team 1 is registered with a second one of the game play computing entities; player 1 of team 2 is registered with a third one of the game play computing entities; and player 2 of team 2 is registered with a fourth one of the game play computing entities.

In this example, the game scoring computing entity 16-1 sets up the 2-player versus 2-player team game by determining, or receiving from the game play computing entitles, a grid for each of the players (e.g., grid 1 of pro level for player 1 of team 1; grid 3 of advanced level for player 2 of team 1; grid 2 of pro level for player 1 of team 1; and grid 5 of intermediate level for player 2 of team 2). The game scoring computing entity 16-1 then determines a round by round, player versus player match up for the game.

For example: in round 1, player 1 of team 1 competes against player 1 of team 2; in round 2, player 2 of team 1 competes against player 2 of team 2; in round 3, player 1 of team 1 competes against player 2 of team 2; in round 4, player 2 of team 1 competes against player 1 of team 2; and in round 5, the players of each team play alternate hitting the golf ball. As another example, the players from each team alternate hitting the ball in each round, alternating who hits 2 of the 5 balls and who hits 3 of the 5 balls.

When the game is ready to begin, the game scoring computing entity 16-1 sends a signal to the game play computing entity 16-2 affiliated with the player who is to hit the first ball of the game. The game scoring module 80 of the affiliated game play computing entity generates a score for the hit ball (e.g., 0 points for off-grid, 1 point for on-grid, etc.) in a manner as described herein and sends the score to the game scoring computing entity 16-1. The game scoring computing entity 16-1 records the score in a score card and provides a graphics image, or video, of the score card to the game playing computing entities 16-2. The game playing computing entities may display the score card.

After recording the score for the first hit ball, the game scoring computing entity 16-1 sends a signal to the game play computing entity 16-2 affiliated with the player who is to hit the second ball of the game. The game scoring module 80 of the affiliated game play computing entity generates a score for the hit ball and sends the score to the game scoring computing entity 16-1. The game scoring computing entity 16-1 records the score in a score card as described above. This process continues until all of the balls in the first round have been hit.

After all of the balls in the first round has been hit, the game scoring computing entity determines if either team has earned a bonus by hitting all five balls on the grid. If so, the game scoring computing entity 16-1 determines a bonus amount for a team, adds it to the team's score for the round, and updates the score card. This processing is repeated for each of the remaining rounds of the game.

After all of the rounds of the game have been completed, the game scoring computing entity 16-1 determines whether one of the teams won (e.g., had the most total points) or whether there is a tie (e.g., both teams have the same total point score). When one of the teams won the game, the game scoring computing entity 16-1 uploads the game score to the national organization computing entity 12 or another organization computing entity. In addition, the game scoring computing entity may calculate team and/or player statistics of the game, which it uploads to the national organization computing entity 12 or another organization computing entity.

FIG. 4D is a schematic block diagram of an example of a plurality game computing entities supporting play of a 5 Drive Golf™ game. The game scoring modules 80 of the game play computing entities 16-2 coordinate game set up, game play, and recording the results of the game. The game set up, play, and recording of results in this embodiment is similar to the game set up, play, and recording of results in the embodiment of FIG. 4C. In this embodiment, however, the game play computing entities coordinate the game set up, play, and recording of results rather than using a game scoring computing entity.

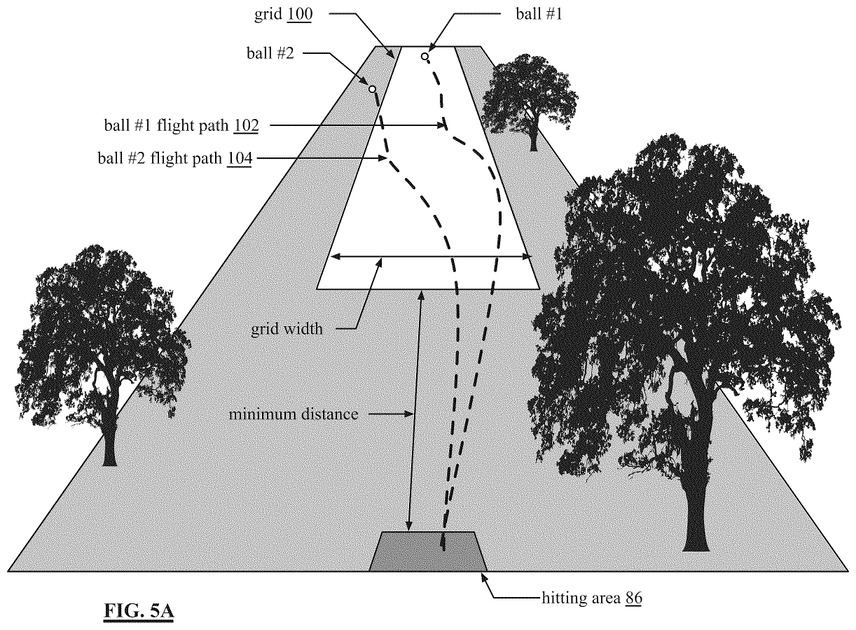

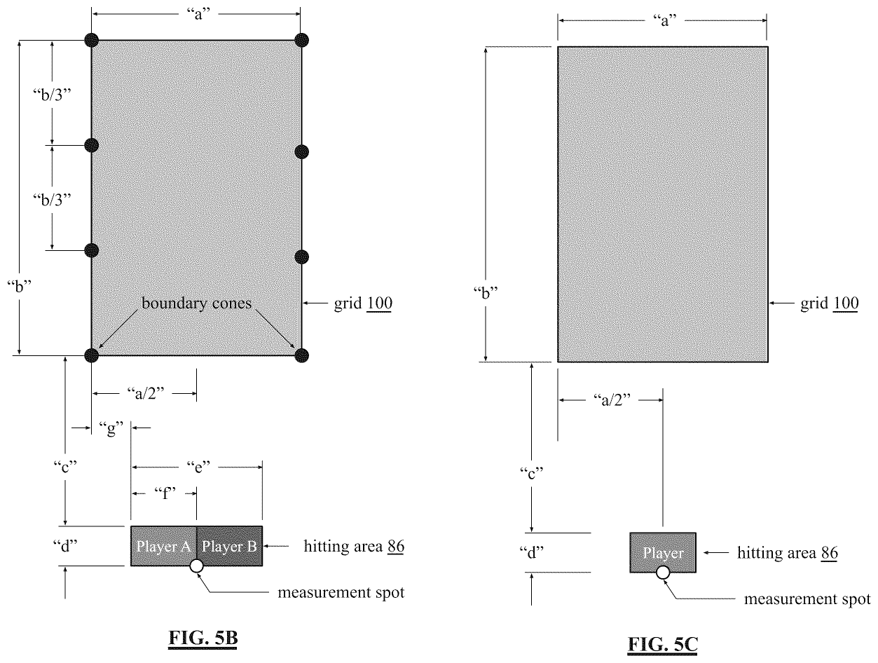

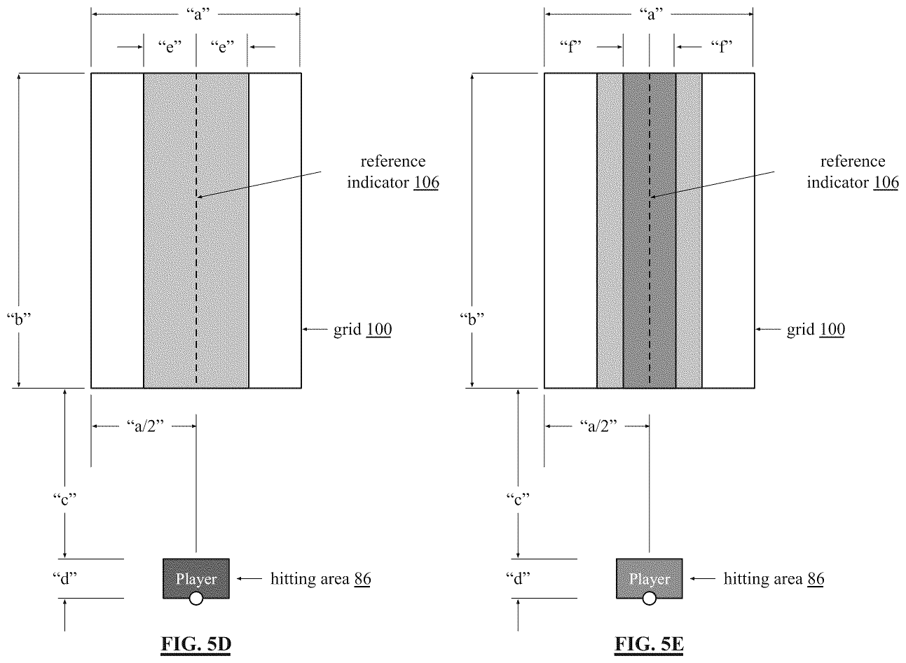

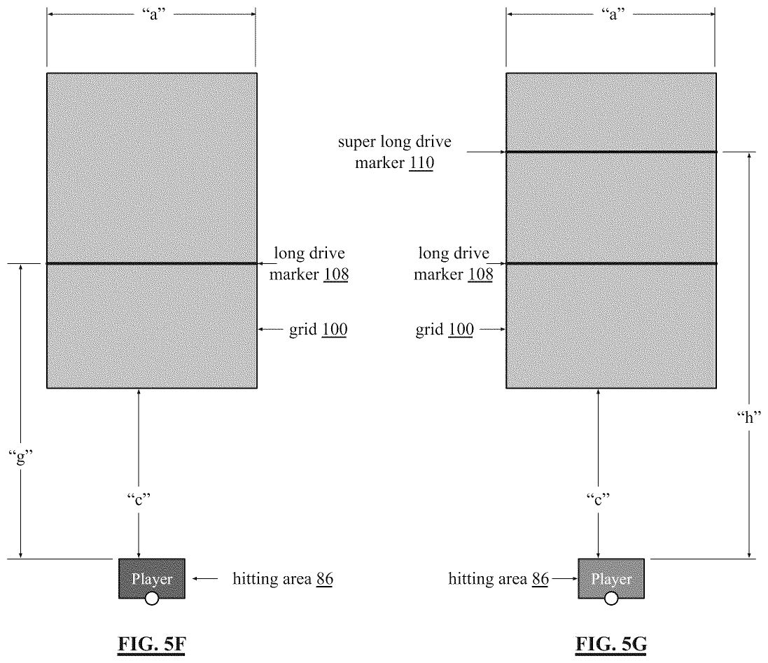

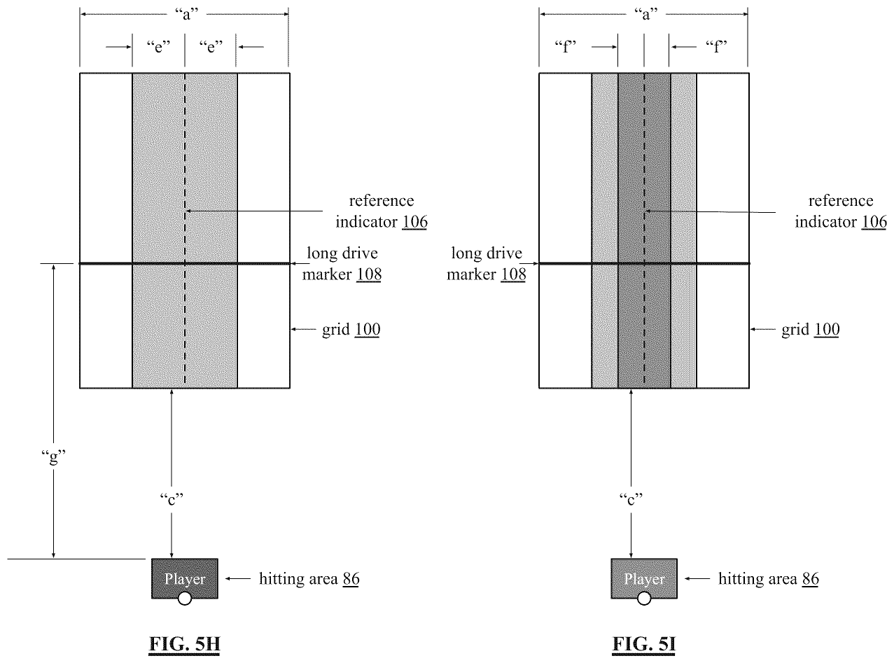

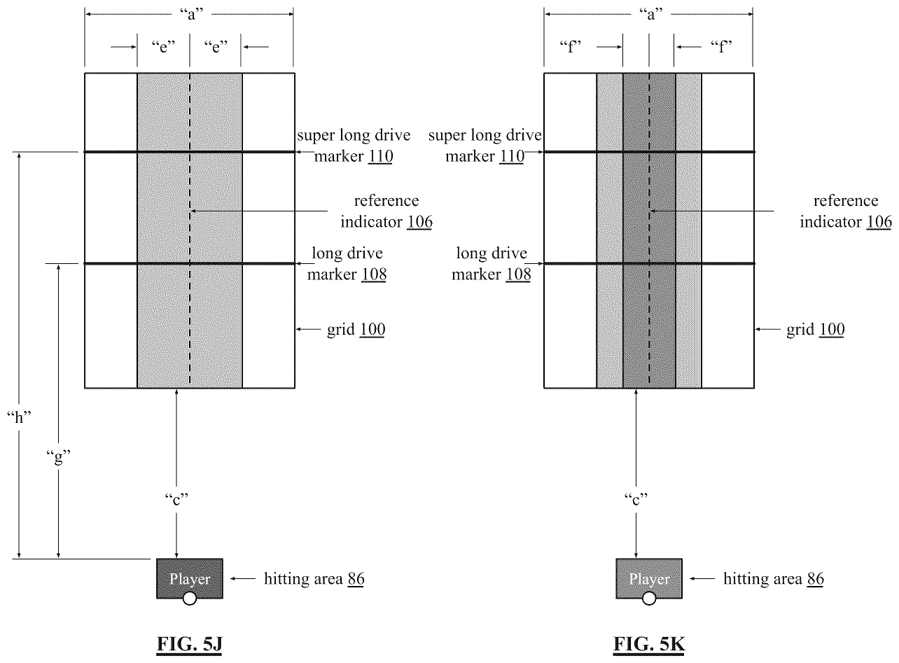

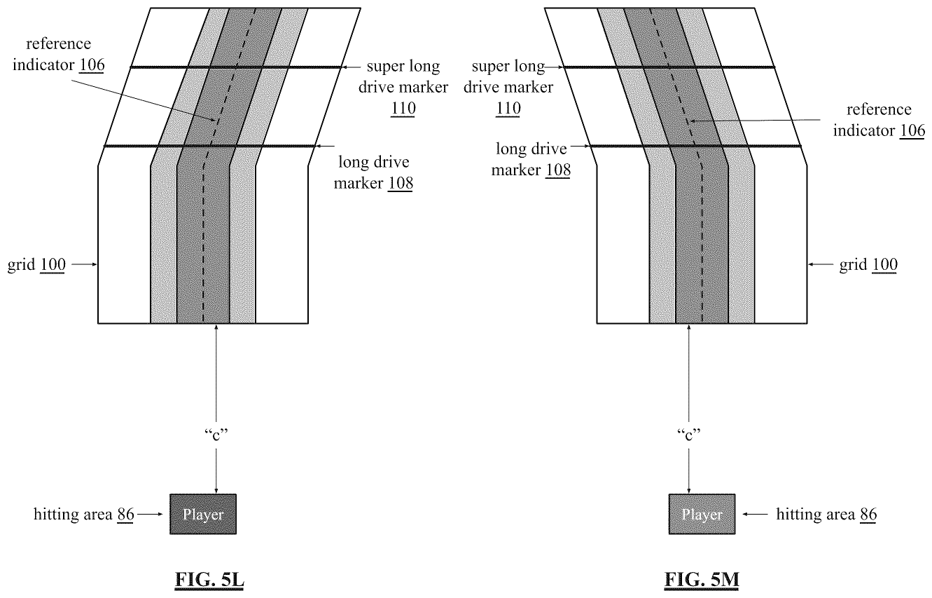

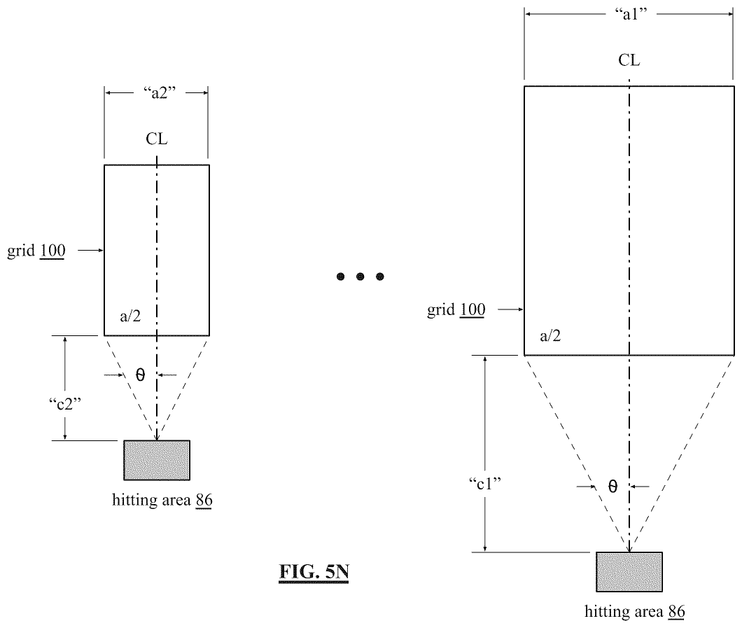

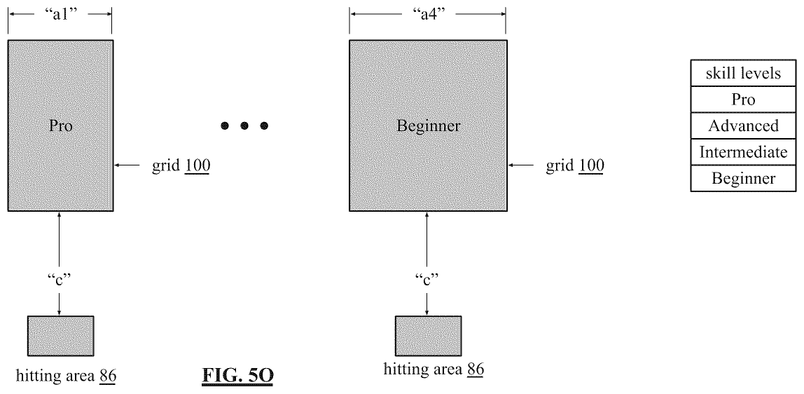

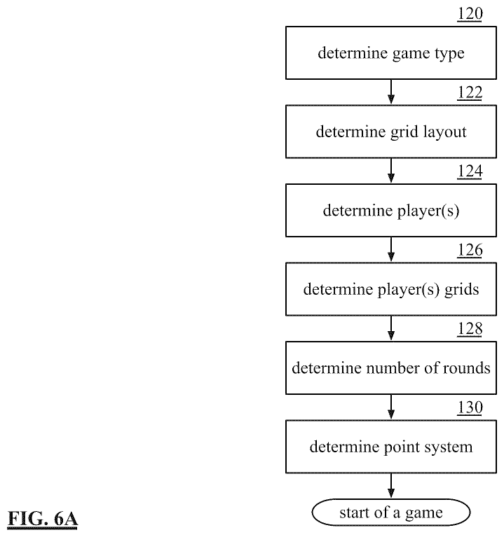

FIGS. 5A-5O are diagram of examples of 5 Drive Golf™ grids. FIG. 5A illustrates a grid 100 that is a minimum distance from a hitting area 86 and has a grid width. A first ball is hit and follows flight path 102 coming to rest in the grid. This hit ball would receive points based on how the grid is set up. A second ball is hit and follows flight path 104 and comes to rest off of the grid. This hit ball would receive no points since it is off the grid.

FIG. 5B illustrates an outdoor grid 100 that is a minimum distance (“c”) from a hitting area 86 and has a grid width (“a”). The hitting area 86 includes two sections: one for player A and one for player B, which allows for both players to hit concurrently or alternating. If the players hit concurrently, each would use its own launch monitor to capture the raw ball data or the raw ball data could be manually captured and entered into a game computing entity. Measurements (e.g., distance and deviation from center) of hit balls are with respect to a measurement spot.

The boundaries of the grid 100 are delineated by cones placed in various locations as shown. The cones can be used to further delineate the long drive marker and the super long drive marker. Additional cones may be used to delineate the accurate zone and/or the super accurate zone. The use of cones provides a visual aid to the players without having to mark a driving range of a fairway of a golf course.

FIG. 5C illustrates a grid 100 for outdoor play or indoor play on a simulator. The grid 100 is a minimum distance (“c”) from a hitting area 86 and has a grid width (“a”). The hitting area 86 includes room for one player; as such, the players hit in an alternating manner. The center of the hitting area 86 is aligned with the center of the grid.

FIG. 5D illustrates a grid 100 for outdoor play or indoor play on a simulator. The grid 100 is a minimum distance (“c”) from a hitting area 86 and has a grid width (“a”). The grid 100 further includes an accurate zone that is centered about a reference indicator 106. In an embodiment, the reference indicator is centered in the grid and the width of the accurate zone is about ½ of the grid width, such that ½*a=2*e. In another embodiment, the reference indicator 106 is off-center of the grid, which allows for different challenges to making a shot.

FIG. 5E illustrates a grid 100 for outdoor play or indoor play on a simulator. The grid 100 is a minimum distance (“c”) from a hitting area 86 and has a grid width (“a”). The grid 100 further includes a super accurate zone that is centered about a reference indicator 106. In an embodiment, the reference indicator is centered in the grid and the width of the super accurate zone is about ¼ of the grid width, such that ¼*a=2*f. In another embodiment, the reference indicator 106 is off-center of the grid, which allows for different challenges to making a shot.

FIG. 5F illustrates a grid 100 for outdoor play or indoor play on a simulator. The grid 100 is a minimum distance (“c”) from a hitting area 86 and has a grid width (“a”). The grid 100 further includes a long drive marker 108 that is a distance “g” from the hitting area 86. The distance “g” (long drive) is greater than distance “c” (minimum distance).

FIG. 5G illustrates a grid 100 for outdoor play or indoor play on a simulator. The grid 100 is a minimum distance (“c”) from a hitting area 86 and has a grid width (“a”). The grid 100 further includes a long drive marker 108 that is a distance “g” from the hitting area 86 and a super long drive marker 110 that is a distance “h” from the hitting area. The distance “h” (super long drive) is greater than distance “g” (long drive).

FIG. 5H illustrates a grid 100 for outdoor play or indoor play on a simulator. The grid 100 is a minimum distance (“c”) from a hitting area 86 and has a grid width (“a”). The grid 100 further includes a long drive marker 108 and an accurate zone defined by dimension “e”.

FIG. 5I illustrates a grid 100 for outdoor play or indoor play on a simulator. The grid 100 is a minimum distance (“c”) from a hitting area 86 and has a grid width (“a”). The grid 100 further includes a long drive marker 108, an accurate zone defined by dimension “e”, and a super accurate zone defined by dimension “f”.

FIG. 5J illustrates a grid 100 for outdoor play or indoor play on a simulator. The grid 100 is a minimum distance (“c”) from a hitting area 86 and has a grid width (“a”). The grid 100 further includes a long drive marker 108, a super long drive marker 110, and an accurate zone defined by dimension “e”.

FIG. 5K illustrates a grid 100 for outdoor play or indoor play on a simulator. The grid 100 is a minimum distance (“c”) from a hitting area 86 and has a grid width (“a”). The grid 100 further includes a long drive marker 108, a super long drive marker 110, an accurate zone defined by dimension “e”, and a super accurate zone defined by dimension “f”.

FIG. 5L illustrates a grid 100 for outdoor play or indoor play on a simulator. The grid 100 is a minimum distance (“c”) from a hitting area 86 and has a grid width (“a”). The grid 100 further includes one or more of a long drive marker 108, a super long drive marker 110, an accurate zone defined by dimension “e”, and a super accurate zone defined by dimension “f”. In this embodiment, the grid dog-legs to the left. Note that the long drive and/or super long drive markers may be before or after the dog leg.

FIG. 5M illustrates a grid 100 for outdoor play or indoor play on a simulator. The grid 100 is a minimum distance (“c”) from a hitting area 86 and has a grid width (“a”). The grid 100 further includes one or more of a long drive marker 108, a super long drive marker 110, an accurate zone defined by dimension “e”, and a super accurate zone defined by dimension “f”. In this embodiment, the grid dog-legs to the right. Note that the long drive and/or super long drive markers may be before or after the dog leg.

FIG. 5N illustrates scaled grids 100 for outdoor play or indoor play on a simulator. Each grid 100 is a minimum distance (“c”) from a hitting area 86 and has a grid width (“a”). Depending on a player's distance ability (e.g., average drive distance), the grid is proportionally scaled to allow players of different distance abilities to compete fairly. To keep competition substantially fair, a margin angle θ is kept substantially constant. In equation form:

tan θ=(0.5*a)/c, where “a” is the grid width and “c” is the minimum distance.

Since θ is substantially constant, then a1/c1=a2/c2, where a1 is the grid width of grid 1, c1 is the minimum distance of grid 1, a2 is the grid width of grid 2, and c2 is the minimum distance of grid 2. For example, if c1=330 yards, a1=48 yards, and its desired that c2=0.9*c1 (297), then a2=(48/330)*297=43.2. Rounding up c2 to the nearest multiple of 5, the minimum distance for grid 2 (c2) is 300 yards. Rounding up a2 to the nearest multiple of 2″, where n is 1 if the grid includes an accurate zone and n=2 if the grid also includes a super accurate zone, which is 44 for both cases of n. The rounding up functions simplify the numbers and maintains the fairness of players with different distance abilities.

FIG. 5O illustrates scaled grids 100 for outdoor play or indoor play on a simulator. Each grid 100 is a minimum distance (“c”) from a hitting area 86 and has a grid width (“a”). Depending on a player's accuracy ability (e.g., driving consistency, percentage of fairways hit), the grid is proportionally scaled to allow players of different accuracy abilities to compete fairly.

As an example of scaling the width of a grid, assume that grid 1 of a Pro accuracy level has a minimum distance of 330 yards and a grid width of 48 yards. For a grid 1 at an Advanced accuracy level, the minimum distance remains 330 yards and the grid width is a scaled version of the 48 yard grid width of the Pro accuracy level grid 1. In an embodiment, the new grid width is determined based on an equation:

(new a)=(known a)+/−x*2ⁿ, where “new a” is the new grid width, “known a” is the grid width of the reference grid, x is an integer multiplier, n is 1 for accurate zone and 2 for accurate and super accurate zone, use + when the reference grid is at a higher accuracy level, and use-when the reference grid is at a lower accuracy level.

Using this equation and setting x=2, then new a=48+2*2², which equals 56. A series of grids can be determined for the Advanced accuracy level using the concepts of FIG. 5N. To determine an Intermediate accuracy level grid 1, the same concepts apply with x being set to 4. To determine a Beginner accuracy level grid 1, the same concepts apply with x being set to 6.

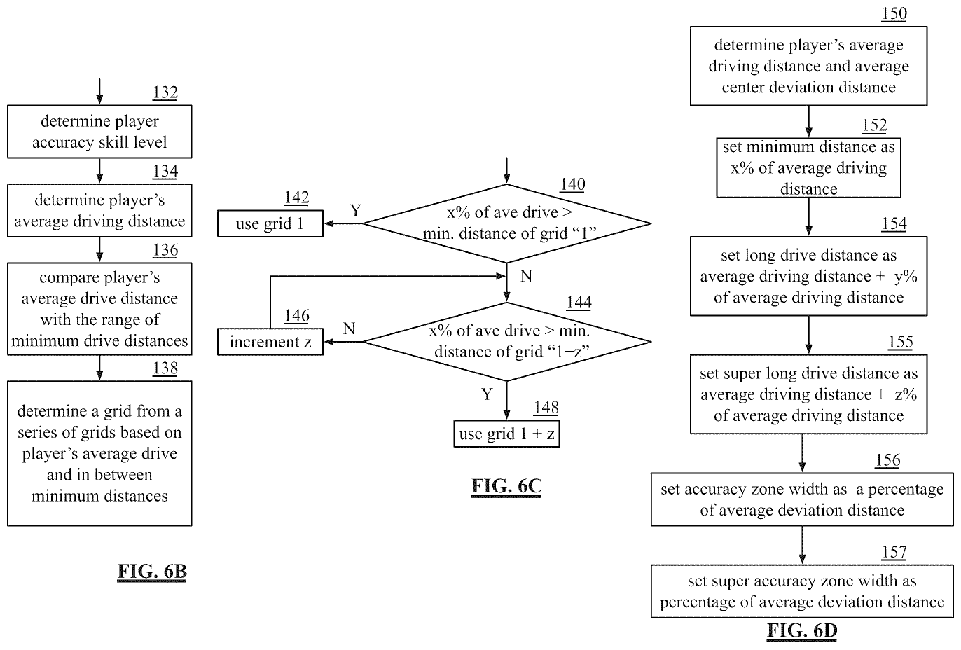

FIG. 6A is a logic diagram of an example of setting up a 5 Drive Golf™ game that begins at step 120 where a game computing entity determines a type of game to be played. For example, will the game be a team versus team game, an open team game (e.g., more than two teams playing), a player versus player game, or an open player game (e.g., more than two players playing).

The method continues at step 122 where the game computing entity determines a grid layout for the game. For example, will the grid include a long drive marker, a super long drive marker, an accurate zone, a super accurate zone, will the reference line be centered or off-center, and/or will the grid be dog-legged.

The method continues to step 124 where the game computing entity determines the players for the game. For example, the game computing entity receives players' 5Drive IDs from a team computing entity, from a player computing entity, manually entered into the game computing entity, etc. and, for team games, the teams' 5Drive IDs. The game computing entity verifies the players' IDs and the teams' IDs. If an ID is not verified, then the player and/or team is not permitted to play in the game.

When the IDs are verified, the method continues at step 126 wherein the game computing device determines a grid for each of the players based on the player's distance ability and accuracy ability. The player's distance and accuracy abilities may be entered into the game computing entity, received from the national organization computing entity, or calculated based on the player's statistics.

The method continues at step 128 where the game computing device determines a number of rounds for the game. For example, the number of rounds may be a default value, such as five. As another example, the number of rounds is an input received from a player, a team, and/or a league.

The method continues at step 130 where the game computing device determines the point system for the game. For example, the point system includes 1 point for on the grid; 2 points for an accurate drive or a long drive; 3 points for a super accurate drive, a super long drive, or a super accurate and long drive; 4 points for a super accurate and long drive or an accurate and super long drive; and 5 points for super accurate and super long drive.

The point system may include a bonus structure. For example, 5 bonus points are awarded if all balls in a round (e.g., 5 balls) come to rest on the grid; 10 bonus points are awarded if all balls in the round come to rest in the accurate zone or beyond the long drive marker; and 15 bonus points are awarded if all balls in the round come to rest in the accuracy zone and beyond the long drive marker.

The point system may further include increasing the points for the last round. For example, per shot points are doubled in the last round. As another example, bonus points are doubled in the last round.

FIG. 6B is a logic diagram of an example method for determining a player's grid. The method begins at step 132 where the game computing entity determines a player's accuracy skill level. For example, the player enters his/her accuracy skill level. As another example, the game computing entities retrieves the player's accuracy skill level from the national organization computing entity. As yet another example, the game computing entity calculates the player's accuracy skill level based on the player's statistics.

The method continues at step 134 where the game computing entity determines a player's average driving distance, which may be done in a variety of ways (e.g., player input, look up, calculated, etc.). The method continues at step 136 where the game computing entity compares the player's average distance with minimum distances of a series of grids for a given accuracy level. The method continues at step 138 where the game computing devices selects a grid where the player's average driving distance is greater than the minimum distance of the grid and is less than the minimum distance of the next higher grid. For example, if grid 1 has a minimum distance of 330 yards, grid 2 has a minimum distance of 350, and the player's average driving distance is 340 yards, then grid 1 is selected.

FIG. 6C is a logic diagram of an example for determining a player's grid for a given accuracy level. The method begins at step 140 where the game computing entity determines whether “x” percentage of the player's average driving distance is greater than a minimum distance of grid 1 of a series of grids, where x ranges from, for example, 80% to 100%. The use of a percentage of the player's average distance allows for customizing the game to have more or less balls reaching the minimum distance and long drive distances. The lower the percentage, the more balls that will reach the minimum distance and/or long drive distances.

If x % of the average driving distance is greater than or equal to the minimum distance of grid 1, the method continues at step 142 where the game computing entity selects grid 1. If, however, x % of the average driving distance is less than the minimum distance of grid 1, the method continues at step 144 where the game computing entity determines whether x % of the average driving distance is greater than the minimum distance of grid 2. If yes, then grid 2 is used.

If x % of the average driving distance is less than the minimum distance of grid 2, the method continues at step 146 where the game computing entity increments z to the next grid (e.g., grid 3) and repeats the method at step 144 until a grid is found.

FIG. 6D is a logic diagram of an example for determining a player's grid based on the player's ability. The method begins at step 150 where the game computing entity determines a player's average driving distance and the player's average deviation from center distance for on grid drives. The method continues at step 152 where the game computing entity sets a minimum distance for the player's grid as a percentage (e.g., 90%) of the player's average driving distance.

The method continues at step 154 where the game computing entity sets a long drive distance for the player's grid as a percentage (e.g., 110%) of the player's average driving distance. The method continues at step 155 where the game computing entity sets a super long drive distance for the player's grid as a percentage (e.g., 120%) of the player's average driving distance.

The method continues at step 156 where the game computing entity sets an accurate zone width for the player's grid as a percentage (e.g., 50%) of the player's average deviation from center distance. The method continues at step 157 where the game computing entity sets a super accurate zone width for the player's grid as a percentage (e.g., 20%) of the player's average deviation from center distance.

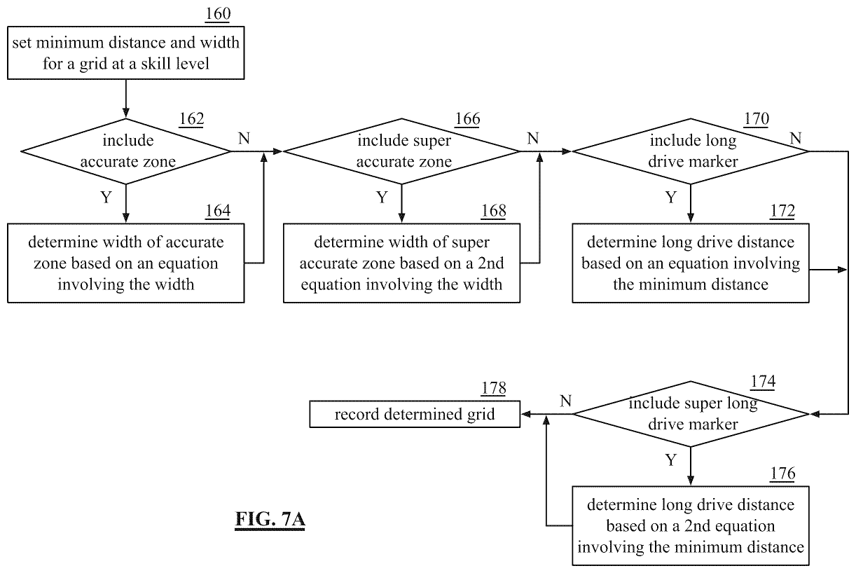

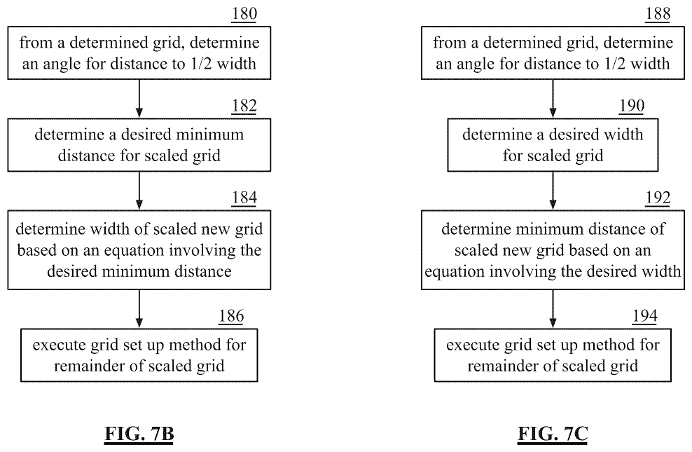

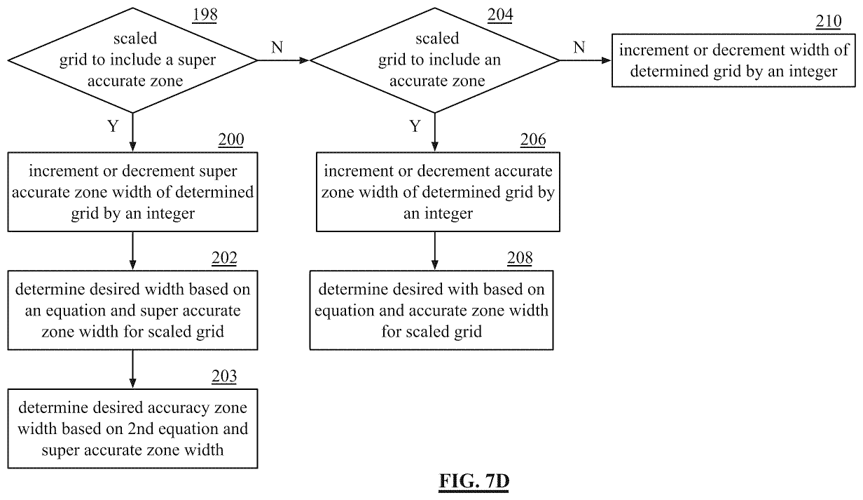

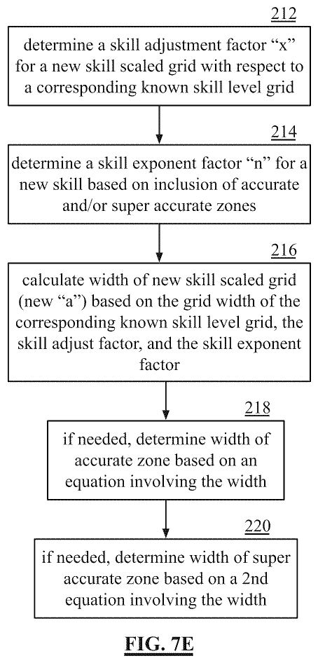

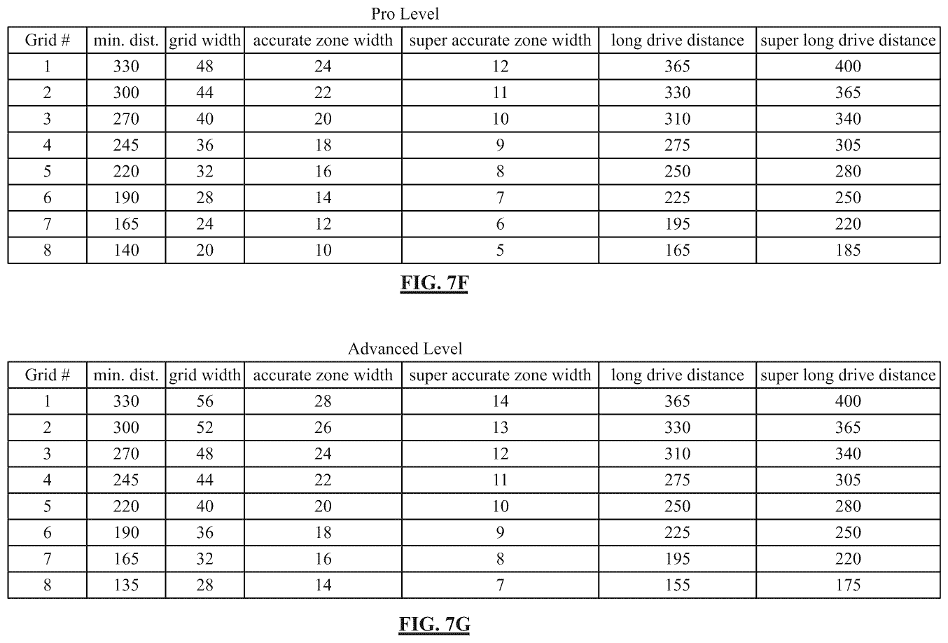

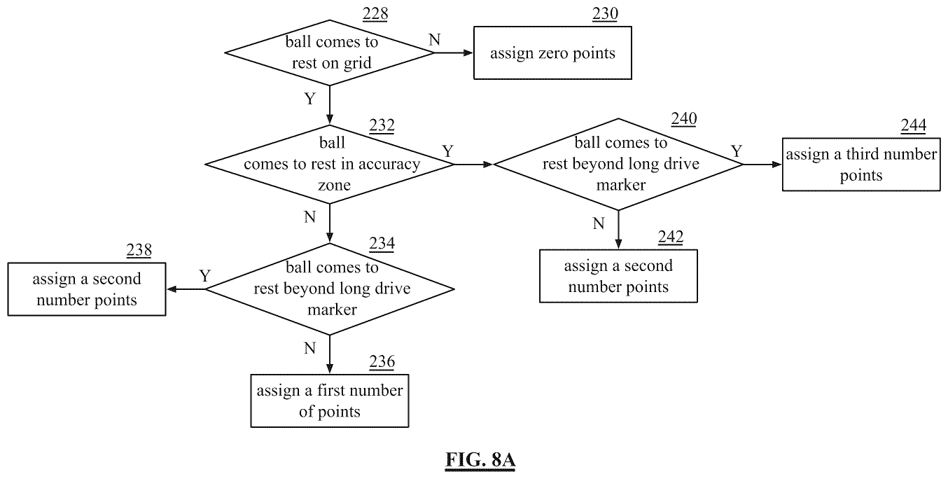

FIGS. 7A-7E are logic diagram of examples of creating a plurality of 5 Drive Golf™ grid for various player's distance and/or skill levels. The method of FIG. 7A begins at step 160 where the game computing entity sets a minimum distance and width for a grid based on a distance and accuracy skill. For example, the game computing entity sets a Pro accuracy level grid to have a minimum distance of 330 yards and a width of 48 yards.

The method continues at step 162 where the game computing entity determines whether an accuracy zone is to be included on the grid. For example, the game computing entity receives an input regarding the inclusion of an accurate zone. If the grid is to include an accurate zone, the method continues at step 164 where the game computing entity determines a width for the accurate zone based on an equation involving the width. For example, the accurate zone width is equal to one-half the grid width.

The method continues at step 166 where the game computing entity determines whether a super accuracy zone is to be included on the grid. If the grid is to include a super accurate zone, the method continues at step 168 where the game computing entity determines a width for the super accurate zone based on a second equation involving the width. For example, the super accurate zone width is equal to one-quarter the grid width.

The method continues at step 170 where the game computing entity determines whether a long drive marker is to be included on the grid. If the grid is to include a long drive marker, the method continues at step 172 where the game computing entity determines a distance for the long drive marker based on an equation involving the minimum distance. For example, the long drive distance is equal to the minimum distance multiplied by a multiplier (e.g., 1.1) rounded up to the nearest multiple of five.

The method continues at step 174 where the game computing entity determines whether a super long drive marker is to be included on the grid. If the grid is to include a super long drive marker, the method continues at step 176 where the game computing entity determines a distance for the super long drive marker based on a second equation involving the minimum distance. For example, the super long drive distance is equal to the minimum distance multiplied by a second multiplier (e.g., 1.2) rounded up to the nearest multiple of five. The method continues to step 178 where the game computing entity records the parameters of the grid.

FIG. 7B is a logic diagram of an example of a method for determining other grids in a series of grids for a given accuracy level. The method begins at step 180 where the game computing device determines an angle for the minimum distance and ½ of the width for a known grid. For example, for grid 1 of a Pro accuracy level grid series, the minimum distance is 330 yards and ½ of the width is 24 yards, which produces an angle of about 4.135°. (e.g., tan (24/330)). The method continues at step 182 where the game computing entity determines a desired minimum distance for a scaled grid. As an example, select 300 yards for the minimum distance for grid 2 of the Pro accuracy level grid series.

The method continues at step 184 where the game computing entity determines width of the scaled grid based on an equation involving the desired minimum distance. As an example for the grid 2 of the Pro accuracy level grid series and selected minimum distance of 300 yards, the scaled grid width=2*300*(24/330), which equals 43.64. Rounding up to the nearest multiple of 4, the grid width for grid 2 is 44 yards. The method continues at step 186 where the game computing entity executes steps 162-178 of FIG. 7A to complete the scaled grid set up.

FIG. 7C is a logic diagram of an example of a method for determining other grids in a series of grids for a given accuracy level. The method begins at step 188 where the game computing device determines an angle for the minimum distance and ½ of the width for a known grid. For example, for grid 1 of a Pro accuracy level grid series, the minimum distance is 330 yards and ½ of the width is 24 yards, which produces an angle of about 4.135°. (e.g., tan (24/330)). The method continues at step 190 where the game computing entity determines a desired grid width for a scaled grid. As an example, select 44 yards for the minimum distance for grid 2 of the Pro accuracy level grid series.

The method continues at step 192 where the game computing entity determines the minimum distance of the scaled grid based on an equation involving the desired grid width. As an example for the grid 2 of the Pro accuracy level grid series and selected grid width is 44 yards, the scaled minimum distance=½*44*(330/24), which equals 302.5. Rounding up to the nearest multiple of 5, the minimum distance for grid 2 is 300 yards. The method continues at step 194 where the game computing entity executes steps 162-178 of FIG. 7A to complete the scaled grid set up.

FIG. 7D is a logic diagram of an example of a method for determining grids in a series of grids for different accuracy levels based on a known grid of an accuracy level. For grids of a different accuracy level, only the widths are changed, and the distances are the same as of other accuracy levels. The method begins at step 198 where the game computing entity determines whether the scaled grid will include a super accurate zone.

If yes, the method continues at step 200 where the game computing entity increments or decrements the width of the super accurate zone by an integer. For example, when scaling from a more accurate to a less accurate grid, the super accurate zone is incremented by an integer (e.g., 1, 2, 3). As another example, when scaling from a less accurate to a more accurate grid, the super accurate zone is decremented by an integer.

The method continues at step 202 where the game computing entity determines a grid width for the scaled grid based on an equation and the super accurate zone width. For example, the grid width is four times the super accurate zone width. The method continues at step 203 where the game computing entity determines an accurate zone width for the scaled grid based on another equation and the super accurate zone width. For example, the accurate zone width is two times the super accurate zone width.

If the grid will not include a super accurate zone, the method continues at step 204 where the game computing entity determines whether the scaled grid will include an accurate zone. If not, the method continues at step 210 where the game computing entity increments or decrements the width by an integer. For example, when scaling from a more accurate to a less accurate grid, the width is incremented by an integer (e.g., 4, 8, 12). As another example, when scaling from a less accurate to a more accurate grid, the grid width is decremented by an integer.

If the grid is to include an accurate zone, the method continues at step 206 where the game computing entity increments or decrements the width of the accurate zone by an integer. For example, when scaling from a more accurate to a less accurate grid, the accurate zone is incremented by an integer (e.g., 2, 4, 6). As another example, when scaling from a less accurate to a more accurate grid, the accurate zone is decremented by an integer. The method continues at step 208 where the game computing entity determines a grid width for the scaled grid based on an equation and the accurate zone width. For example, the grid width is two times the accurate zone width.

FIG. 7E is a logic diagram of another example of a method for determining grids in a series of grids for different accuracy levels based on a known grid of an accuracy level. For grids of a different accuracy level, only the widths are changed, and the distances are the same as of other accuracy levels. The method begins at step 212 where the game computing entity determines a skill adjustment factor “x” for a new skill scaled grid with respect to a corresponding known skill level grid. For example, the corresponding known skill level grid is grid 1 of the Pro accuracy level and the new skill scaled grid is grid 1 of the Advanced Accuracy level. As a further example, the game computing device determines the skill adjustment factor by a look up using the Pro level as the corresponding known level and the new level (e.g., World Champ, Advanced, Intermediate, Beginner). For instance, x equals −2 for World Champ, equals 2 for Advanced, equals 4 for Intermediate, and 6 for Beginner.

The method continues at step 214 where the game computing entity determines a skill exponent factor “n” for the new skill level grid based on inclusion of an accurate zone and/or of a super accurate zone. For example, n equals 1 for accurate zone only and n equals 2 for super accurate zone.

The method continues at step 216 where the game computing entity calculates the width of the scaled grid based on the grid width of the corresponding grid, the skill adjustment factor, and the skill exponent factor. For example, the new width equals the known width+x*2ⁿ. As a specific example, if the known width is 48 yards, the accurate level is going from Pro to Advance, and the grid includes a super accurate zone, the new width is 48+2*2², which equals 56. As another specific example, if the known width is 48 yards, the accurate level is going from Pro to Beginner, and the grid includes a super accurate zone, the new width is 48+6*2², which equals 72. As yet another specific example, if the known width is 48 yards, the accurate level is going from Pro to World Champ, and the grid includes a super accurate zone, the new width is 48−2*2², which equals 40.

The method continues at step 218 where, if needed, the game computing entity determines the width of the accurate zone for the scaled grid based on an equation and the width. The method continues at step 220 where, if needed, the game computing entity determines the width of the super accurate zone for the scaled grid based on a second equation and the width.

FIGS. 7F-7G are diagram of examples of a plurality of 5 Drive Golf™ grid for various player's distance and/or skill levels. In particular, FIG. 7F illustrates dimensions for 8 grids of a Pro accuracy level series of grids and FIG. 7G illustrates dimensions for 8 grids of an Advance accuracy level series of grids.

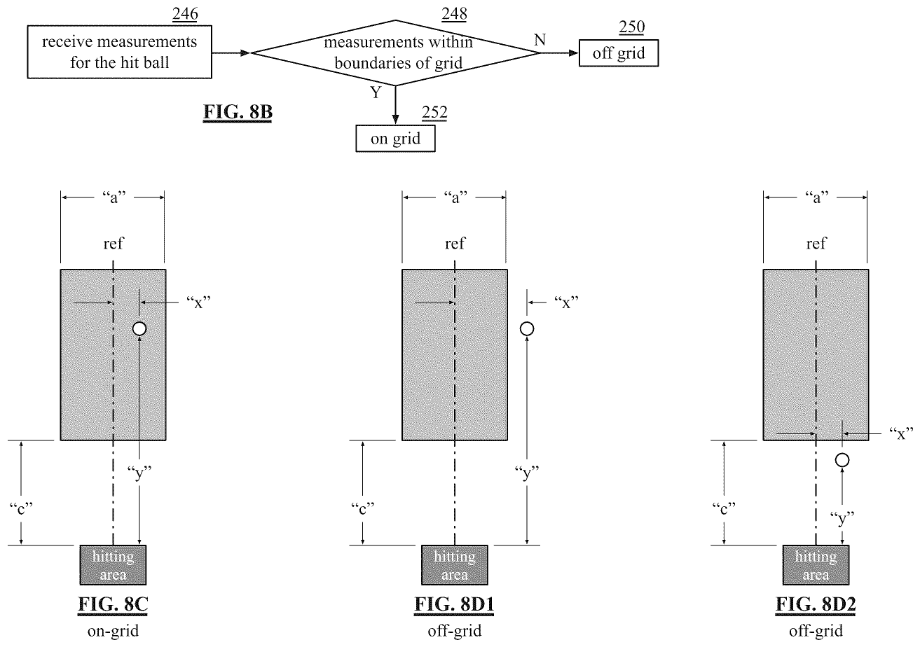

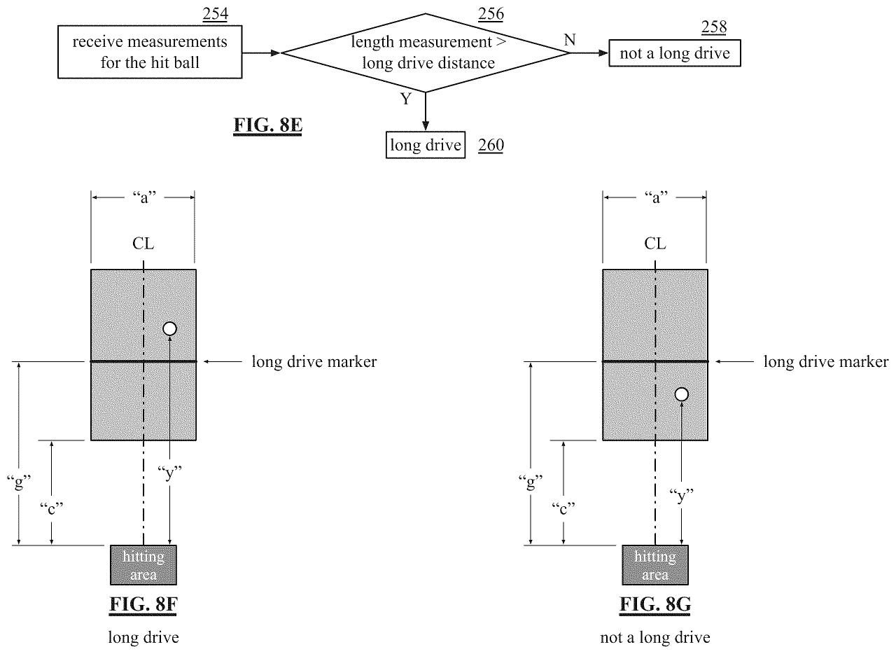

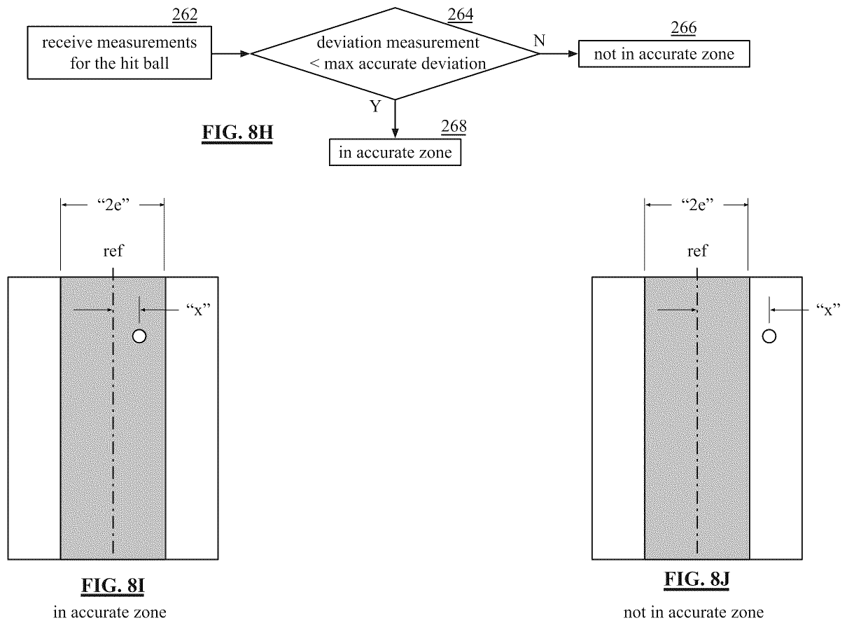

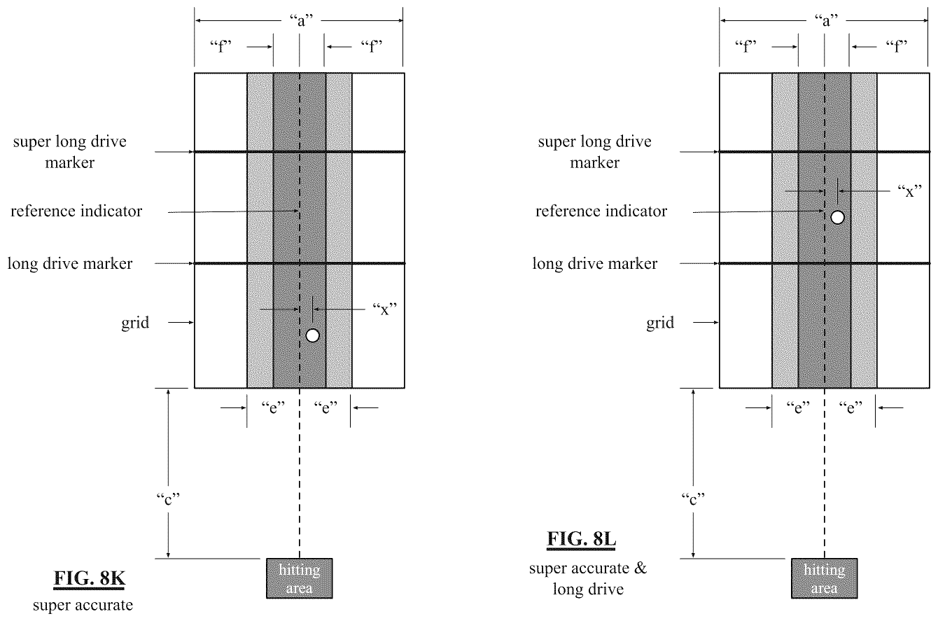

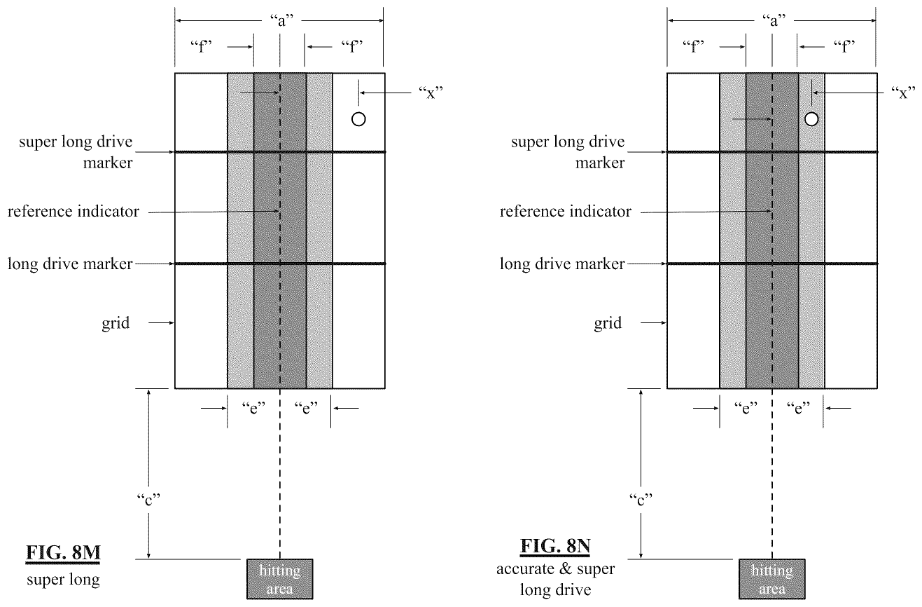

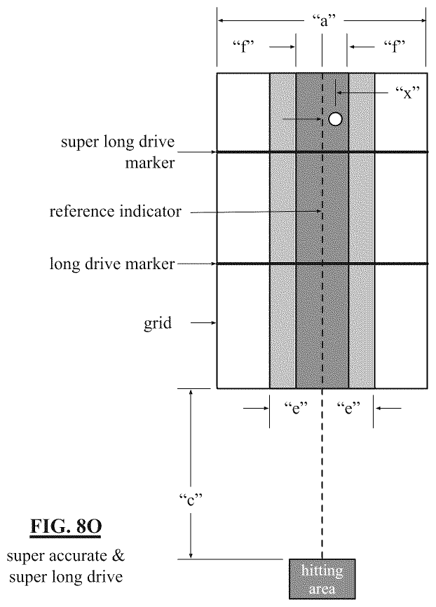

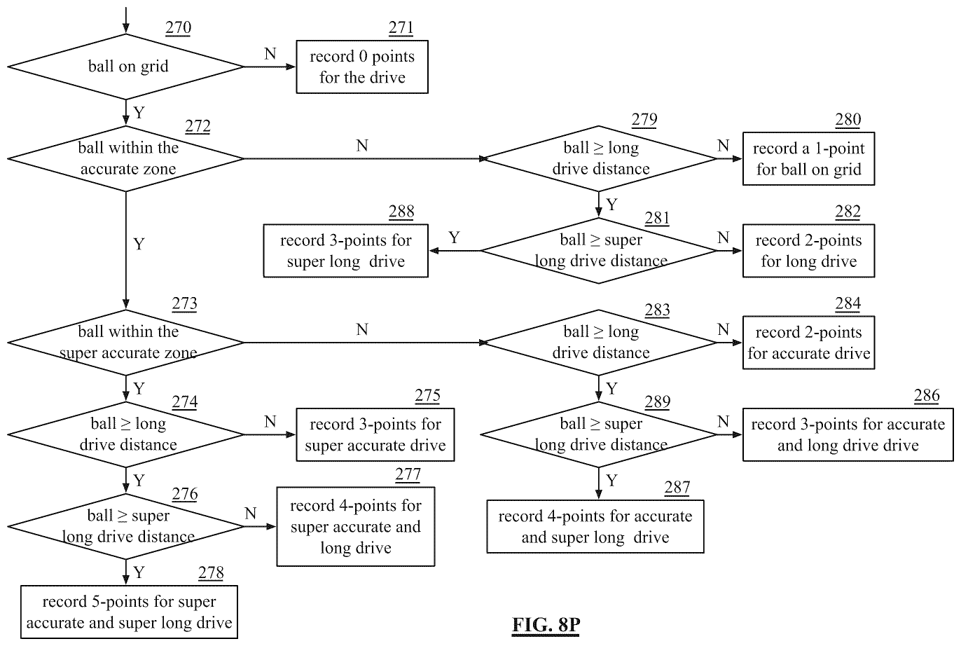

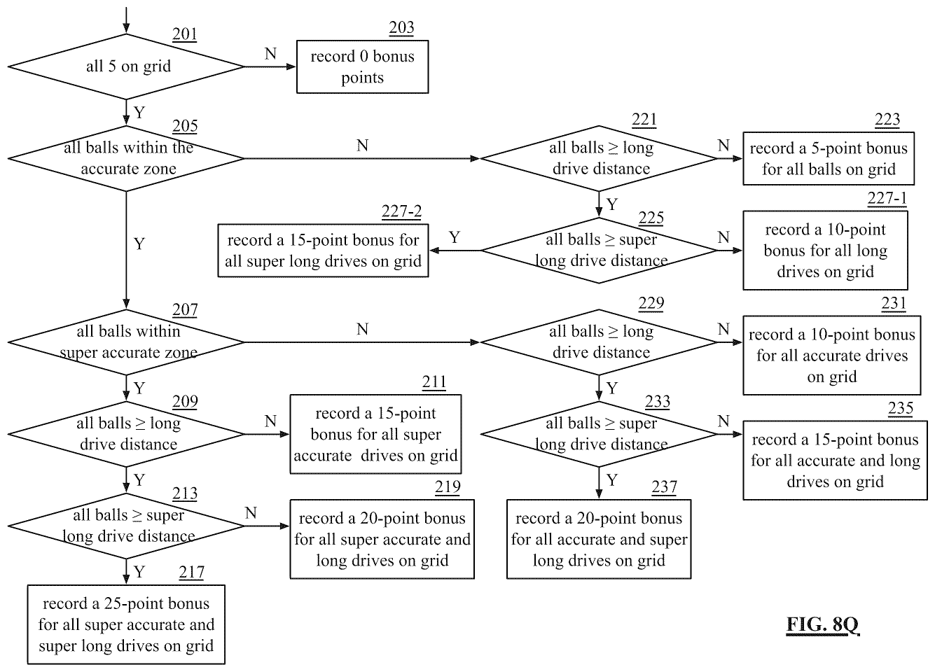

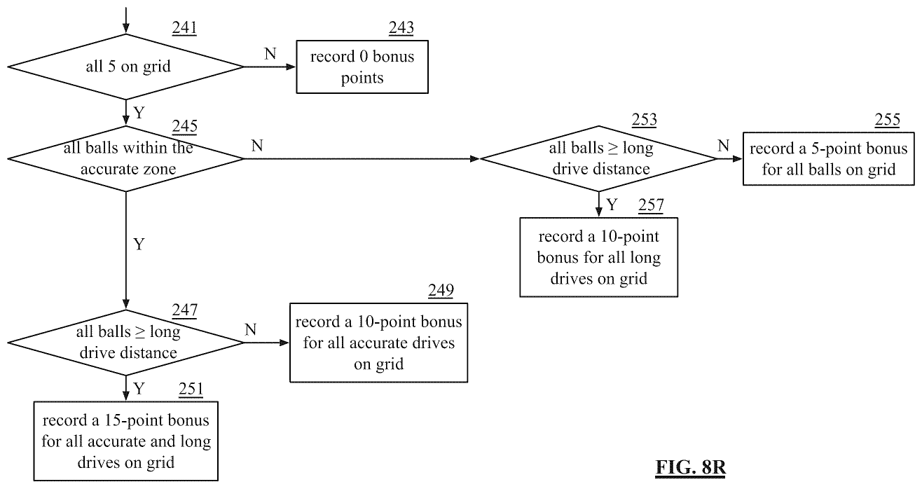

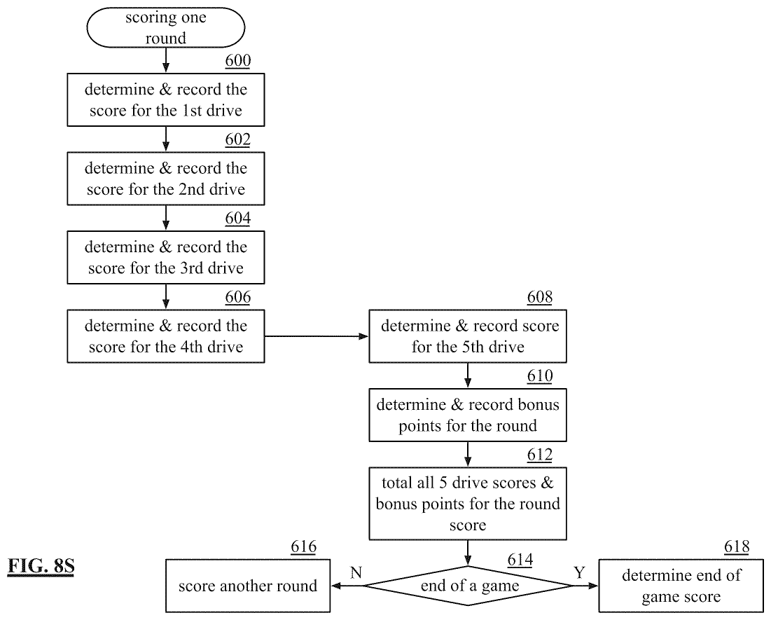

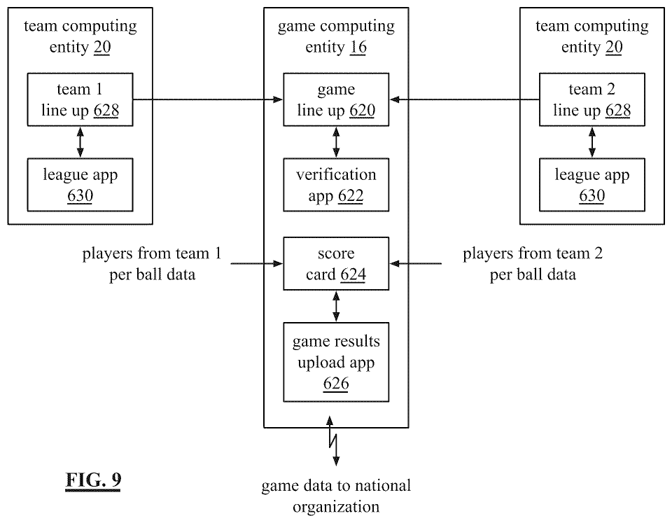

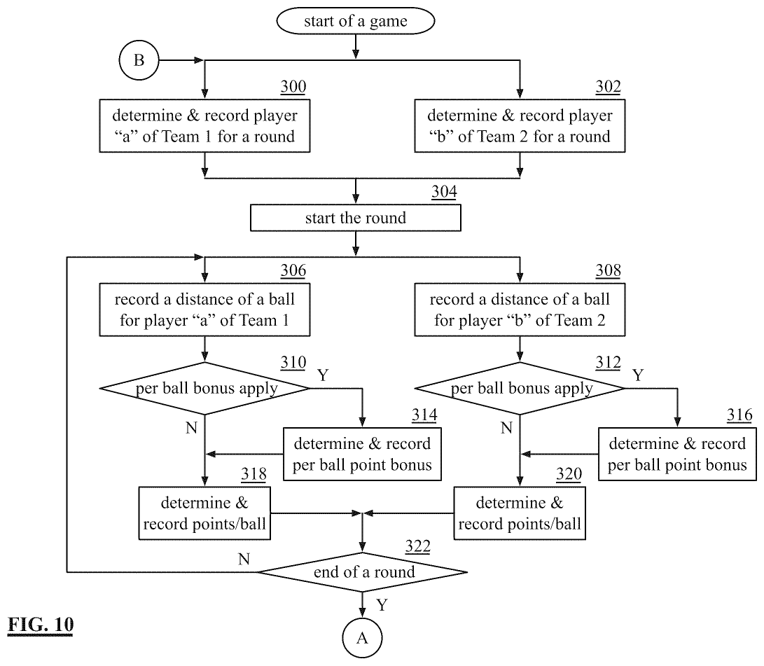

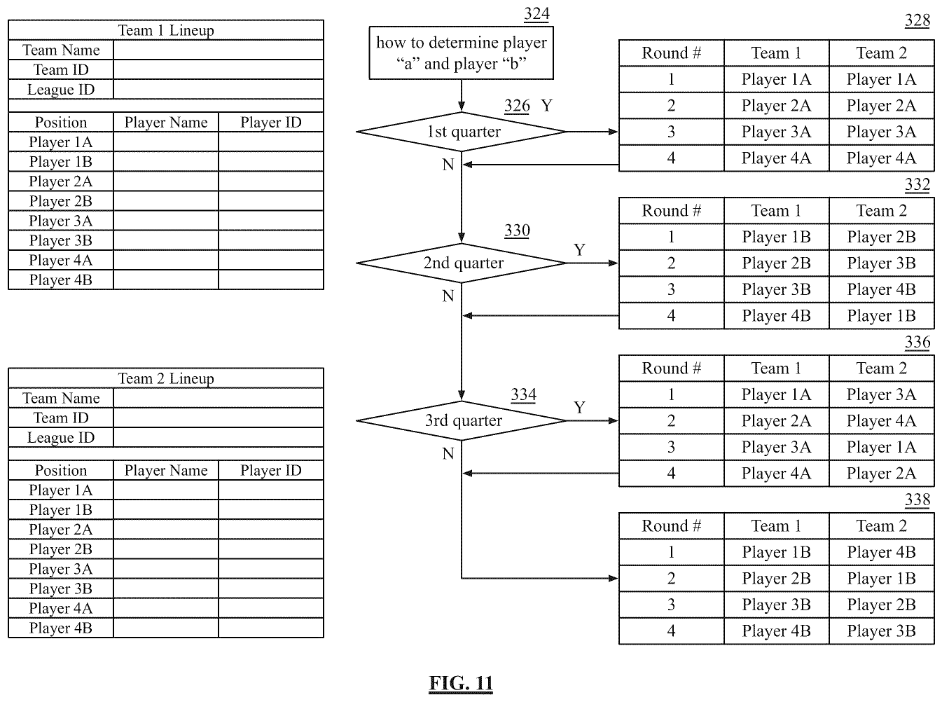

FIGS. 8A-8S are logic diagram of examples of scoring a 5 Drive Golf™ game. FIG. 8A illustrates an example of a method that begins at step 228 where the game computing entity determines whether a hit ball comes to rest on a grid. If not, the method continues at step 230 where the game computing entity assigns no points for the hit ball and the method repeats at step 228 for the next hit ball.

When the ball came to rest on the grid, the method continues at step 232 where the game computing entity determines whether the hit ball comes to rest within an accuracy zone of the grid. If not, the method continues at step 234 where the game computing entity determines whether the hit ball comes to rest beyond a long drive marker of the grid. If not, the method continues at step 236 where the game computing entity assigns a first number of points (e.g., 1 point for an on-grid ball) and the method repeats at step 228 for the next ball.

When the hit ball is not in the accuracy zone and is beyond the long drive marker, the method continues at step 238 where the game computing entity assigns a second number of points (e.g., 2 points for a long drive) and the method repeats at step 228 for the next ball.

When the hit ball comes to rest within the accuracy zone, the method continues at step 240 where the game computing entity determines whether the hit ball comes to rest beyond a long drive marker of the grid. If not, the method continues at step 244 where the game computing entity assigns the second number of points or a different number of points (e.g., 2 points for an accurate drive to weight equally with distance, less or more to weight differently) and the method repeats at step 228 for the next ball.

When the hit ball comes to rest within the accuracy zone and comes to rest beyond the long drive marker, the method continues at step 244 where the game computing entity assigns a third number of points (e.g., 3 points for an accurate and long drive) and the method repeats at step 228 for the next ball.

FIG. 8B illustrates an example of a method for determining whether a hit ball comes to rest on the grid. The method begins at step 246 where the game computing entity receives measurements regarding where the hit ball has come to rest. The measurements included a distance from the hitting area and a deviation from the reference line. The method continues at step 248 where the game computing entity determines whether the measurements are within boundaries of the grid. When the measurements are not within the boundaries of the grid, the method continues at step 250 where the game computing entity determines that the hit ball did not come to rest within the grid (i.e., off-grid). When the measurements are within the boundaries of the grid, the method continues at step 252 where the game computing entity determines that the hit ball came to rest within the grid (i.e., on-grid).

FIG. 8C illustrates a diagram of an example of a hit ball coming to rest on the grid. In this illustration, “c” is the minimum distance, “a” is the grid width, “y” is the ball's distance from the hitting area, and “x” is the deviation from center. In this example, “y” is greater than “c”; thus, the ball was driven past the minimum distance. Further, “x” is less than ½ of “a”; thus the ball is within the width of the grid. Since “y” is greater than “c” and “x” is less than ½ of “a”, the hit ball came to rest on the grid.

FIG. 8D1 illustrates a diagram of an example of a hit ball coming to rest off of the grid. In this illustration, “c” is the minimum distance, “a” is the grid width, “y” is the ball's distance from the hitting area, and “x” is the deviation from center. In this example, “y” is greater than “c”; thus, the ball was driven past the minimum distance. However, “x” is greater than ½ of “a”; thus the ball is outside the width of the grid. As such, the ball is off-grid.

FIG. 8D2 illustrates a diagram of an example of a hit ball coming to rest off of the grid. In this illustration, “c” is the minimum distance, “a” is the grid width, “y” is the ball's distance from the hitting area, and “x” is the deviation from center. In this example, “y” is less than “c”; thus, the ball was not driven past the minimum distance. As such, the ball is off-grid.

FIG. 8E illustrates an example of a method for determining whether a hit ball comes to rest on the grid and beyond the long drive marker. The method begins at step 254 where the game computing entity receives measurements regarding where the hit ball has come to rest. The measurements included a distance from the hitting area and a deviation from the reference line. The method continues at step 256 where the game computing entity determines whether the measurements are within boundaries of the grid and whether the distance the ball was hit exceeds the long drive marker. When ball's distance is less than the long drive marker, the method continues at step 258 where the game computing entity determines that the hit ball is on the grid, but is not a long drive. When the ball's distance exceeds the long drive marker, the method continues at step 260 where the game computing entity determines that the hit ball came to rest beyond the long drive marker (i.e., on-grid and a long drive).

FIG. 8F illustrates a diagram of an example of a hit ball coming to rest on the grid beyond the long drive marker. In this illustration, “c” is the minimum distance, “a” is the grid width, “g” is the long drive marker distance, “y” is the ball's distance from the hitting area, and “x” is the deviation from center. In this example, “y” is greater than “g”; thus, the ball was driven past the long drive marker. Further, “x” is less than ½ of “a”; thus the ball is within the width of the grid. Since y” is greater than “g” and “x” is less than ½ of “a”, the hit ball came to rest on the grid and is beyond the long drive marker.

FIG. 8G illustrates a diagram of an example of a hit ball coming to rest on the grid but is not beyond the long drive marker. In this illustration, “c” is the minimum distance, “a” is the grid width, “g” is the long drive marker distance, “y” is the ball's distance from the hitting area, and “x” is the deviation from center. In this example, “y” is greater than “c” and is less than “g”; thus, the ball was driven past the minimum distance but not past the long drive marker. Further, “x” is less than ½ of “a”; thus the ball is within the width of the grid. Since y” is greater than “c” and less than “g” and “x” is less than ½ of “a”, the hit ball came to rest on the grid but short of the long drive marker.

FIG. 8H illustrates an example of a method for determining whether a hit ball comes to rest on the grid and within an accurate zone. The method begins at step 262 where the game computing entity receives measurements regarding where the hit ball has come to rest. The measurements included a distance from the hitting area and a deviation from the reference line. The method continues at step 264 where the game computing entity determines whether the measurements are within boundaries of the grid and whether the deviation from the reference line is within the accurate zone. When ball's deviation from the accurate zone is greater than ½ of the accurate zone width, the method continues at step 266 where the game computing entity determines that the hit ball is on the grid, but is not within the accurate zone. When the ball's deviation from the reference line is less than ½ of the accurate zone width, the method continues at step 268 where the game computing entity determines that the hit ball came to rest within the accurate zone (i.e., on-grid and in accurate zone).

FIG. 8I illustrates a diagram of an example of a hit ball coming to rest on the grid and within the accurate zone. In this illustration, “c” is the minimum distance, “a” is the grid width, “2e” is the width of the accurate zone centered about the reference line, “y” is the ball's distance from the hitting area, and “x” is the deviation from center. In this example, “y” is greater than “c” and “x” is less than “e” (i.e., ½ of the accurate zone width); thus the hit ball came to rest on the grid and is within the accurate zone for an accurate drive.

FIG. 8J illustrates a diagram of an example of a hit ball coming to rest on the grid and not within the accurate zone. In this illustration, “c” is the minimum distance, “a” is the grid width, “2e” is the width of the accurate zone centered about the reference line, “y” is the ball's distance from the hitting area, and “x” is the deviation from center. In this example, “y” is greater than “c” and “x” is greater than “e” (i.e., ½ of the accurate zone width) and less than “a”; thus the hit ball came to rest on the grid and but is not within the accurate zone for an on-grid drive.

FIG. 8K illustrates a diagram of an example of a hit ball coming to rest on the grid and within a super accurate zone. In this illustration, “c” is the minimum distance, “a” is the grid width, “2e” is the width of the accurate zone centered about the reference line, “2f” is the width of the super accurate zone centered about the reference line, “y” is the ball's distance from the hitting area, and “x” is the deviation from center. In this example, “y” is greater than “c” and “x” is less than “f” (i.e., ½ of the super accurate zone width); thus the hit ball came to rest on the grid and within the super accurate zone for a super accurate drive.

FIG. 8L illustrates a diagram of an example of a hit ball coming to rest on the grid within the super accurate zone and beyond the long drive marker. In this illustration, “c” is the minimum distance, “a” is the grid width, “2e” is the width of the accurate zone centered about the reference line, “2f” is the width of the super accurate zone centered about the reference line, “y” is the ball's distance from the hitting area, “g” is the long drive marker distance, and “x” is the deviation from center. In this example, “y” is greater than “g” and “x” is less than “f” (i.e., ½ of the super accurate zone width); thus the hit ball came to rest on the grid, within the super accurate zone and beyond the long drive marker for an accurate and long drive.

FIG. 8M illustrates a diagram of an example of a hit ball coming to rest on the grid beyond the super long drive marker. In this illustration, “c” is the minimum distance, “a” is the grid width, “2e” is the width of the accurate zone centered about the reference line, “2f” is the width of the super accurate zone centered about the reference line, “y” is the ball's distance from the hitting area, a super long drive marker is shown, and “x” is the deviation from center. In this example, “y” is greater than the super long drive marker and “x” is greater than “e” (i.e., ½ of the accurate zone width) and less than “a”; thus the hit ball came to rest on the grid beyond the super long drive marker for a super long drive.

FIG. 8N illustrates a diagram of an example of a hit ball coming to rest on the grid within the accurate zone and beyond the super long drive marker. In this illustration, “c” is the minimum distance, “a” is the grid width, “2e” is the width of the accurate zone centered about the reference line, “2f” is the width of the super accurate zone centered about the reference line, “y” is the ball's distance from the hitting area, a super long drive marker is shown, and “x” is the deviation from center. In this example, “y” is greater than the super long drive marker and “x” is less than “e” (i.e., ½ of the accurate zone width) and greater than “f”; thus the hit ball came to rest on the grid beyond the super long drive marker and within the accurate zone for a super long and accurate drive.

FIG. 8O illustrates a diagram of an example of a hit ball coming to rest on the grid within the super accurate zone and beyond the super long drive marker. In this illustration, “c” is the minimum distance, “a” is the grid width, “2e” is the width of the accurate zone centered about the reference line, “2f” is the width of the super accurate zone centered about the reference line, “y” is the ball's distance from the hitting area, a super long drive marker is shown, and “x” is the deviation from center. In this example, “y” is greater than the super long drive marker and “x” is less than “f” (i.e., ½ of the super accurate zone width); thus the hit ball came to rest on the grid beyond the super long drive marker and within the super accurate zone for a super long and super accurate drive.

FIG. 8P is a logic diagram of another example of a method for scoring a hit ball in a 5Drive game. The method begins at step 270 where a game computing entity determines whether a ball is on the grid. If not, the method continues at step 271 where the game computing entity assigns zero points to the ball and the method repeats at step 270 for another ball.

If the ball is on the grid, the method continues at step 272 where the game computing entity determines whether the ball is within an accurate zone. If yes, the method continues at step 273 where the game computing entity determines whether the ball is within a super accurate zone. If yes, the method continues at step 274 where the game computing entity determines whether the ball was driven past a long drive distance. If not, the method continues at step 275 where the game computing entity assigns 3 points for a super accurate drive.

If the ball is driven past the long drive distance, the method continues at step 276 where the game computing entity determines whether the ball was driven past a super long drive distance. If yes, the method continues at step 278 where the game computing entity assigns 5 points for a super long and super accurate drive. If not, the method continues at step 277 where the game computing entity assigns 4 points for a super accurate and long drive.

If, at step 272, the ball was not within the accurate zone, the method continues at step 279 where the game computing entity determines whether the ball was driven past a long drive distance. If not, the method continues at step 280 where the game computing entity assigns 1 point for an on-grid drive. If yes, the method continues at step 281 where the game computing entity determines whether the ball was driven past a super long drive distance. If not, the method continues at step 282 where the game computing entity assigns 2 points for a long drive. If yes, the method continues at step 288 where the game computing entity assigns 3 points for a super long drive.

If, at step 273, the ball was not within the super accurate zone, the method continues at step 283 where the game computing entity determines whether the ball was driven past a long drive distance. If not, the method continues at step 284 where the game computing entity assigns 2 points for an accurate drive. If yes, the method continues at step 289 where the game computing entity determines whether the ball was driven past a super long drive distance. If not, the method continues at step 286 where the game computing entity assigns 3 points for an accurate and long drive. If yes, the method continues at step 287 where the game computing entity assigns 4 points for an accurate and super long drive.

FIG. 8Q is a logic diagram of an example for determining an end of round bonus. The method begins at step 201 where the game computing entity determines whether one team or a player hit all of the balls of a round (e.g., five balls) on the grid. If not, the method continues at step 203 where the game computing entities assigns zero bonus points for the round.

If all the balls were on the grid, the method continues at step 205 where the game computing entity determines whether all the balls were within the accurate zone. If yes, the method continues at step 221 where the game computing entity determines whether all balls were driven beyond a long drive distance. If not, the method continues at step 223 where the game computing entity assigns a 5 point bonus for all balls on the grid.

If all of the balls were driven past the long drive distance, the method continues at step 225 where the game computing entity determines whether all balls were driven past a super long drive distance. If not, the method continues at step 227-1 where the game computing entity assigns a 10 point bonus for all balls being driven beyond the long drive distance. If yes, the method continues at step 227-2 where the game computing entity assigns a 15 point bonus for all balls being driven beyond the super long drive distance.

If all of the balls were within the accurate zone at step 205, the method continues at step 207 where the game computing entity determines whether all of the balls were with a super accurate zone. If not, the method continues at step 229 where the game computing entity determines whether all of the balls were driven past a long drive distance. If not, the method continues at step 231 where the game computing entity assigns a 10 point bonus for all balls being accurately driven. If yes, the method continues at step 233 where the game computing entity determines whether all of the balls were driven past a super long drive distance. If not, the method continues at step 235 where the game computing entity assigns a 15 point bonus for all balls being driven accurately and beyond the long drive distance. If yes, the method continues at step 237 where the game computing entity assigns a 20 point bonus for all balls being driven accurately and beyond the super long drive distance.

If, at step 207, all balls were driven within the super accurate zone, the method continues at step 209 where the game computing entity determines whether all of the balls were driven past the long drive distance. If not, the method continues at step 211 where the game computing entity assigns a 15 point bonus for all balls being with the super accurate zone. If yes, the method continues at step 213 where the game computing entity determines whether all balls where driven past the super long drive distance. If not, the method continues at step 219 where the game computing entity assigns a 20 point bonus for all balls being super accurate and beyond the long drive distance. If yes, the method continues at step 217 where the game computing entity assigns a 25 point bonus for all balls being super accurate and super long.

FIG. 8R is a logic diagram of an example for determining an end of round bonus. The method begins at step 241 where the game computing entity determines whether one team or a player hit all of the balls of a round (e.g., five balls) on the grid. If not, the method continues at step 243 where the game computing entities assigns zero bonus points for the round.

If all of the balls are hit on the grid, the method continues at step 245 where the game computing entity determines whether all of the balls were driven within the accurate zone. If not, the method continues at step 253 where the game computing entity determines whether all of the balls were driven beyond the long drive distance. If not, the method continues at step 255 where the game computing entity assigns a 5 point bonus for all balls on the grid. If yes, the method continues at step 257 where the game computing entity assigns a 10 point bonus for all balls being driven past the long drive distance.

If, at step 245, all of the balls are within the accurate zone, the method continues at step 247 where the game computing entity determines whether all of the balls were driven past the long drive distance. If not, the method continues at step 249 where the game computing entity assigns a 10 point bonus for all balls being in the accurate zone. If yes, the method continues at step 251 where the game computing entity assigns a 15 point bonus for all balls being in the accurate zone and being beyond the long drive distance, which could be labeled a “Golden Eagle” bonus.

FIG. 8S is a logic diagram of an example of a method for round by round scoring to complete a game. The method begins at step 600 where a game computing entity determines and records a score for a first drive by each team or by each player as described herein. The method continues at step 602 where a game computing entity determines and records a score for a second drive by each team or by each player. The method continues at step 604 where a game computing entity determines and records a score for a third drive by each team or by each player. The method continues at step 606 where a game computing entity determines and records a score for a fourth drive by each team or by each player. The method continues at step 608 where a game computing entity determines and records a score for a fifth drive by each team or by each player.

The method continues at step 610 where a game computing entity determines and records bonus points for each team or for each player. The method continues at step 612 where a game computing entity totals the drive scores and the bonus points for each team or for each player for the round. The method continues at step 614 where a game computing entity determines whether game has ended (e.g., all scheduled rounds have been played). If yes, the method continues at step 618 where the game computing entity determines the final score. If no, the method continues at step 616 where the game computing entity repeats this method to score another round.

FIG. 9 is a schematic block diagram of an embodiment of team computing entities 20 communicating with a game computing entity 16. Each of the team computing entities stores a line up application 628 and a league application 630. The game computing entity 16 stores a game line up application 620, a verification application 622, a score card application 624, and a game results application 626.

To set up a team versus team game, the team computing entities generate a lineup of its players using the lineup application 628, which pulls data regarding the players from an organization (e.g., national, regional, recreational, professional) computing entity via the league application 630. The team computing entities provide their respective lineups to the game computing entity.

The game computing entity records the team lineups using the game lineup application 620. Prior to starting a game, the game computing entity uses the verification application 622 to verify the teams, the players, and the league, if applicable. During the game, the game computing entity records the game score using the score card application 624. After the game is completed, the game computing entity uploads the game result and player statistics using the game results upload application 626.

FIG. 10 is a logic diagram of an example of a method for tracking a round of 5 Drive Golf™ by one or more game computing devices. For example, Teams 1 and Team 2 associated respectively with a first team computing device and a second computing device, initiate a new game and thus a new round with at least one game computing device (e.g., one game computing device is shared between teams, each team uses one game computing device, an individual player uses a game computing device (e.g., players on a team do not need to be in the same physical location), etc.). As another example, a new round begins within an ongoing game (e.g., from step B).

At the start of a round, the method begins with step 300 where player “a” of Team 1 is determined and recorded for the round by the one or more game computing devices and with step 302 where player “b” of Team 2 is determined and recorded for the round by the one or more game computing devices. The one or more game computing devices determine players “a” and “b” by communicating with a team computing device and/or a player computing device to determine a team lineup. A team lineup includes the names of the players on the team, player identifiers (IDs) of the players on the team, and each player's position. A player's position may determine the order of play. As another example, the order of play is determined by the one or more game computing devices.

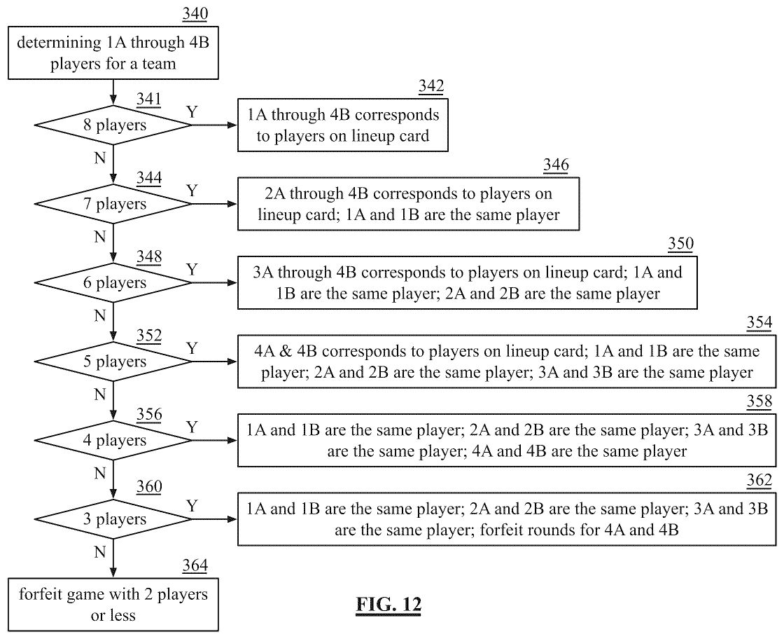

For example, in a head to head competition, the position 1 players on both teams compete in the first round, the position 2 players compete in the second round, and so on. As another example, the one or more game computing devices use a scrambling pattern to determine the players for each round. The scrambling pattern may be random, predetermined, based on a team strategy, based on a directive from the national organization, based on a directive from the recreational organization, etc. As another example, the number of players on each team determine the lineup. Determining team lineups is discussed in more detail with reference to FIGS. 11-12.

Once players “a” and “b” are determined, the one or more game computing devices records players “a” and “b” to begin generating a score card for each player. Recording players “a” and “b” includes storing player information in connection to the round (e.g., a player name, a nickname, the player's team, etc.). Further information may be recorded and/or displayed for view by other players and/or spectators such as a player stats, a player ID number, ranking, performance information, location, height, weight, gender, league information, professional history, etc.

The method continues at step 304 where the round begins (e.g., players “a” and “b” interact with the one or more game computing devices to hit a ball). The method continues with step 306, where the game computing device of the one or more game computing devices associated with player “a” records a distance of a ball for player “a” of Team 1 and at step 308 where the game computing device of the one or more game computing devices associated with player “b” records a distance of a ball for player “b” of Team 2. For example, a game computing device automatically measures the distance, or the distance is measured manually and entered. A zero is recorded for a ball considered not in play. A ball is considered not in play when it is hit out of bounds (e.g., off grid). As another example, a ball is considered not in play if no hit is detected within a certain time frame (e.g., a player skips a turn, fails to hit before an expiration time, etc.). For example, a ball not hit before an expiration of two minutes is recorded as zero yards.

The method continues with step 310, where the game computing device associated with player “a” determines whether per ball bonuses apply and at step 312 where the game computing device associated with player “b” determines whether per ball bonuses apply. Per ball bonuses are extra points granted for a ball driven in a particular spot (e.g., down the middle, hit a target, etc.).

If the game computing device associated with player “a” determines that per ball bonuses apply, the method continues with step 314 where the game computing device determines and records the per ball point bonus for player “a.” The method continues with step 318 where the game computing device determines and records total points for player “a” for the round. For example, 1 point is awarded for a hit on grid and 1 point is awarded for a bonus point for a total of 2 points.

If the game computing device associated with player “b” determines that per ball bonuses apply, the method continues with step 316 where the game computing device determines and records the per ball point points for player “b.” The method continues with step 320 where the game computing device determines and records total points for player “b” for the round. For example, 1 point is awarded for a hit on grid and 1 point is awarded for a bonus point for a total of 2 points.

If the game computing device associated with player “a” determines that per ball bonuses do not apply, the method continues with step 318 where the game computing device determines and records total points for player “a” for the round. If the game computing device associated with player “b” determines that per ball bonuses do not apply, the method continues with step 320 where the game computing device determines and records total points for player “b” for the round. For example, 1 point is awarded for each hit inbounds (e.g., on grid) for both players “a” and “b.”

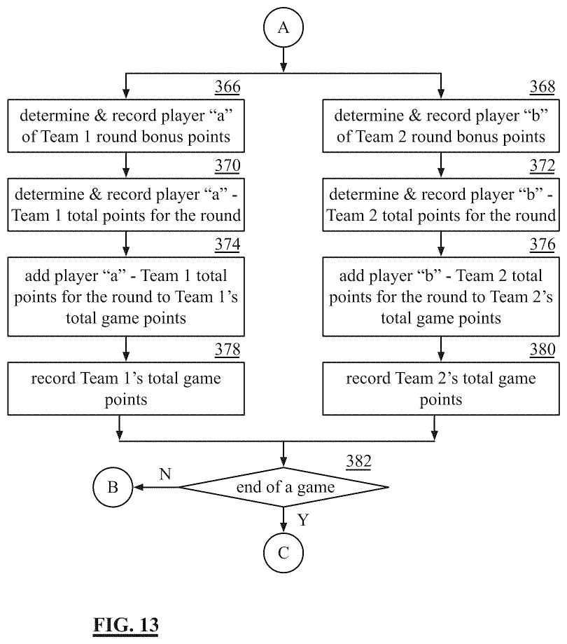

The method continues with step 322 where the one or more game computing devices determine whether the round has ended. For example, a round consists of 5 balls per player. If the round has not ended, the method branches back to steps 306 and 308. If the round has ended (e.g., each player has hit 5 balls), the method continues with step A where end of round points are calculated. Step A is discussed with reference to FIG. 13.

FIG. 11 is a logic diagram of an example of a method for establishing head-to-head competition for a game of 5 Drive Golf™. FIG. 11 depicts examples of team lineup information (e.g., Team 1 Lineup and Team 2 Lineup). The team lineup information includes a team name, team identifier (ID), a league ID, player positions 1A-4B (e.g., up to eight players per team), player names, and player IDs. A team computing device associated with Team 1 communicates the Team 1 lineup with one or more game computing devices associated with Team 1. A team computing device associated with Team 2 communicates the Team 2 lineup with one or more game computing devices associated with Team 2.

For a head-to-head competition for a game of 5 Drive Golf™ consisting of four quarters where each quarter has four rounds, the method begins with step 324 where the one or more game computing devices begin a process to determine player “a” and player “b” for each round of the game. The method continues with step 326 where the one or more game computing devices determine whether the game is in the first quarter. When the game is in the first quarter, the method continues with step 328 where the team lineup information is used to produce a lineup for the first quarter where a first four players of Team 1 (e.g., players 1A-4A from Team 1) go head to head with a first four players of Team 2 (players 1A-4A from Team 2).

After step 328 or when the game is not in the first quarter, the method continues with step 330 where the one or more game computing devices determine whether the game is in the second quarter. When the game is in the second quarter, the method continues with step 332 where the team lineup information is used to produce a lineup for the second quarter where a next four players of Team 1 (e.g., players 1B-4B from Team 1) go head to head with a next four players of Team 2 (players 1B-4B from Team 2).

After step 332 or when the game is not in the second quarter, the method continues with step 334 where the one or more game computing devices determine whether the game is in the third quarter. When the game is in the third quarter, the method continues with step 336 where the team lineup information is used to produce a lineup for the third quarter where a first four players of Team 1 (e.g., players 1A-4A from Team 1) go head to head with a scrambled version of the first four players from Team 2 such that the lineup is different from the first quarter. For example, player 1A from Team 1 goes against player 3A from Team 2, player 2A from Team 1 goes against player 4A from Team 2, player 3A from Team 1 goes against player 1A from Team 2, and player 4A from Team 1 goes against player 2A from Team 2. Different scrambling patterns can be used to ensure the head to head match ups are different for each quarter and/or that each player from Team 1 has competed against each player from Team 2.

After step 336 or when the game is not in the third quarter, the method continues with step 338 where the team lineup information is used to produce a lineup for the fourth quarter where the next four players of Team 1 (e.g., players 1B-4B from Team 1) go head to head with a scrambled version of the next four players from Team 2 such that the lineup is different from the second quarter. For example, a player 1B from Team 1 goes against player 4B from Team 2, a player 2B from Team 1 goes against player 1B from Team 2, a player 3B from Team 1 goes against player 2B from Team 2, and a player 4B from Team 1 goes against player 3B from Team 2. Different scrambling patterns can be used to ensure the head to head match ups are different for each quarter and/or that each player from Team 1 has competed against each player from Team 2.

FIG. 12 is a logic diagram of an example of a method for establishing a team's lineup based on a number of players competing in a game of 5 Drive Golf™. The method begins with step 340 where one or more game computing devices determine player positions 1A-4B for a team. A 5 Drive Golf™ team requires a minimum of 3 players and typically has a maximum of 8 positions. As such, the method determines which players fill positions the 8 positions (1A-4B) when 3-8 players are available.

The method continues with step 341 where the one or more game computing devices determine whether there are 8 players on the team. When there are 8 players, the method continues with step 342 where the one or more game computing devices determines that positions 1A-4B correspond to the 8 players on the lineup card.

When there are not 8 players, the method continues with step 344 where the one or more game computing devices determines whether there are 7 players on the team. When there are 7 players, the method continues with step 346 where the one or more game computing devices determines that positions 2A-4B correspond to the 7 players on the lineup card and players 1A and 1B are the same player.

When there are not 7 players, the method continues with step 348 where the one or more game computing devices determines whether there are 6 players on the team. When there are 6 players, the method continues with step 350 where the one or more game computing devices determines that positions 3A-4B correspond to the 6 players on the lineup card, players 1A and 1B are the same player, and players 2A and 2B are the same player.

When there are not 6 players, the method continues with step 352 where the one or more game computing devices determines whether there are 5 players on the team. When there are 5 players, the method continues with step 354 where the one or more game computing devices determines that positions 4A and 4B correspond to the players on the lineup card, players 1A and 1B are the same player, players 2A and 2B are the same player, and players 3A and 3B are the same player.

When there are not 5 players, the method continues with step 356 where the one or more game computing devices determines whether there are 4 players on the team. When there are 4 players, the method continues with step 358 where the one or more game computing devices determines that players 1A and 1B are the same player, players 2A and 2B are the same player, players 3A and 3B are the same player, and players 4A and 4B are the same player.

When there are not 4 players, the method continues with step 360 where the one or more game computing devices determines whether there are 3 players on the team. When there are 3 players, the method continues with step 362 where the one or more game computing devices determines that positions players 1A and 1B are the same player, players 2A and 2B are the same player, players 3A and 3B are the same player, and a round is forfeited for players 4A and 4B.

When there are not 3 players, the method continues with step 364 where the game is forfeited with a team of 2 players or less.

FIG. 13 is a logic diagram of an example of a method for updating a team's score based on a round of 5 Drive Golf™. At the end of a round (e.g., at step A of FIG. 10), the method continues with step 366 where a game computing device associated with player “a” of Team 1 determines and records player “a's” round bonus points and step 368 where a game computing devices associated with player “b” of Team 2 determines and records player “b's” round bonus points. For example, one or more bonus points (e.g., 4 points) are awarded to the player with the longest distance ball in the round. As another example, on one or more bonus points (e.g., 2 points) are awarded to a player that hits all five balls of the round on-grid (e.g., no drive is recorded as a “0”).

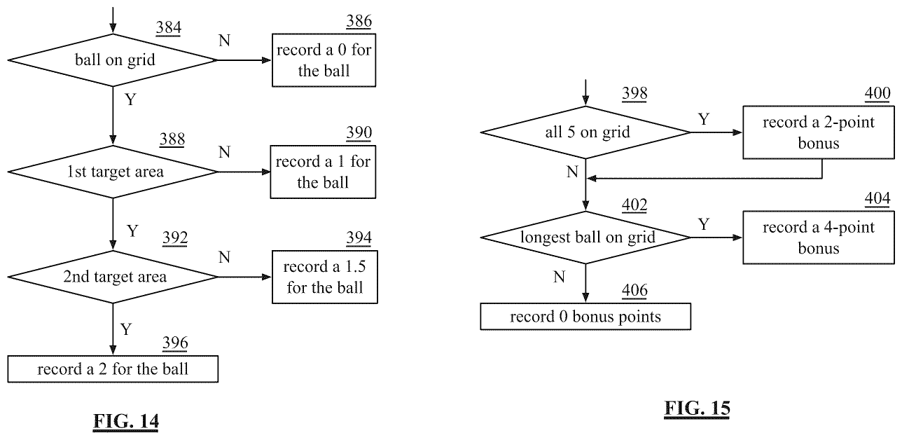

The method continues with step 370 where the game computing device associated with player “a” of Team 1 determines and records player “a's” total points for the round and step 372 where the game computing device associated with player “b” of Team 2's determines and records player “b's” total points for the round. For example, the game computing device adds the per ball points recorded for the round with the end of round bonus points. As an example, for each hit on grid, one point is recorded. If a player hits four out of five balls on grid, 4 points are recorded. Additional per ball points may be awarded for hitting targets or hitting particular zones. An example of per ball scoring is discussed with reference to FIG. 14. Because one ball was not on grid, the player did not receive the bonus of 2 points for hitting all the balls on grid. However, in this example, the player hits the longest ball in the round and receives, a bonus of 4 points. An example of per round bonus scoring is discussed with reference to FIG. 15. The game computing device records the total points for the round for the player as 8 points (e.g., 4 per ball points+4 end of round bonus points).

The method continues with step 374 where a game computing device associated with Team 1 (e.g., the same game computing device as the game computing device associated with player “a” or a different game computing device that is associated with Team 1 and where player “a's” scores are communicated to the different game computing device) adds the total points for the round to Team 1's total game points and step 376 where a game computing device associated with Team 2 (e.g., the same game computing device as the game computing device associated with player “b” or a different game computing device that is associated with Team 2 and where player “b's” scores are communicated to the different game computing device) adds the total points for the round to Team 2's total game points. The method continues with step 378 where the game computing device associated with Team 1 records Team 1's total game points and step 380 where the game computing device associated with Team 2 records Team 2's total game points.

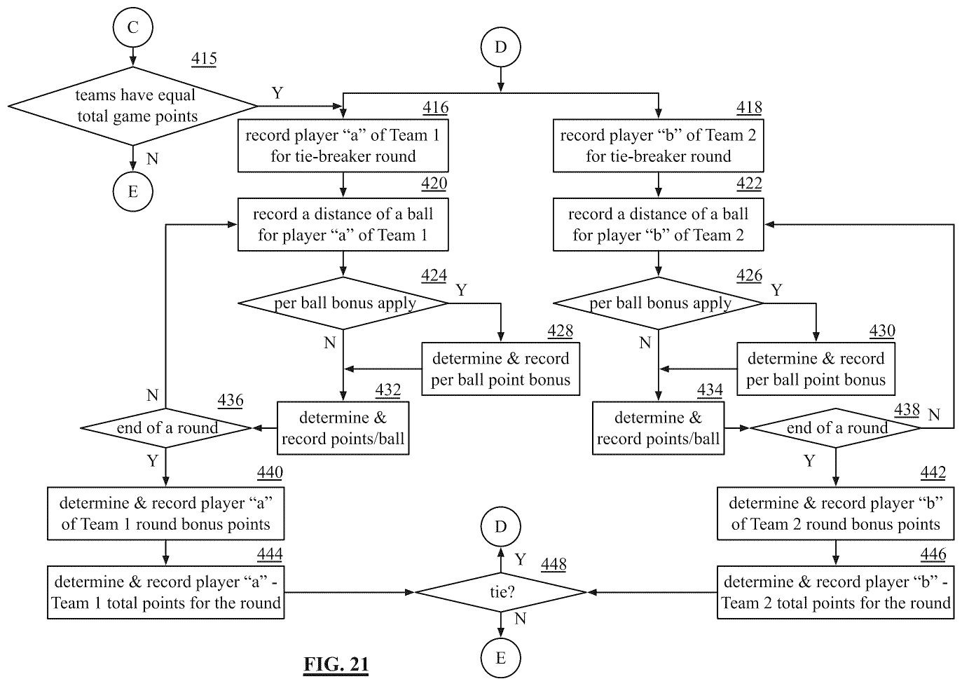

The method continues with step 382 where the game computing device associated with Team 1 and/or the game computing device associated with Team 2 (e.g., “game computing devices”) determine whether the game is over (e.g., a regulation game includes 4 quarters, where each quarter includes 4 rounds). When the game computing devices determine that the game is over, the method continues with step C. Step C will be discussed in greater detail with reference to FIG. 21. When the game computing devices determine that the game is not over, the method continues with step B (e.g., begin a new round as discussed in FIG. 10).

FIG. 14 is a logic diagram of an example of a method for determining per ball points in a round of 5 Drive Golf™. The method begins with step 384 where a game computing device determines whether a ball is hit on grid. For example, the game computing device automatically determines whether the ball is hit on grid or the information is manually entered. If the ball is not hit on grid, the method continues with step 386 where the game computing device records a 0 for the ball.

When the ball is hit on grid, the method continues with step 388 where the game computing device determines whether the ball is hit within a first target area of the grid. For example, the first target area is a specific area on the grid (e.g., at a certain distance on the grid). As another example, the first target area is a center accuracy zone.

When the ball is not hit in the first target area, the method continues with step 390 where the game computing device records a 1 for the ball (e.g., a point for hitting the ball on the grid). When the ball is hit in the first target area, the method continues with step 392 where the game computing determines whether the ball is hit in the second target area. For example, the second target area is at a greater distance on the grid than the first target area such that hitting the second target area also hits the first target area. As another example, the second target area is a narrower center accuracy zone within the first target area on the grid such that hitting the second target area also hits the first target area.

When the ball is not hit in the second target area, the method continues with step 394 where the game computing device records a 1.5 for the ball (e.g., a point for hitting the ball on grid and a half point for hitting the ball in the first target area). When the ball is hit in the second target area, the method continues with step 396 where the game computing device records a 2 for the ball (e.g., a point for hitting the ball on grid and a point for hitting the ball in the second target area).

The game may include zero, one, two, or more target areas and the scores could be different numbers. In another embodiment, the second target area is not within the first target area. For example, the first target area may be areas to the left and right of center area and the second target area is the center. The same scoring system applies but the method flows differently.

For example, if the first target area is or is not hit, the method would continue with the game computing device determining if the second target area is hit. When the first and second target area are not hit, then the game computing device records a 1 for the ball. When the first target area is hit, and the second target area is not hit, then the game computing device records a 1.5 for the ball. When the second target area is hit (e.g., regardless of whether the first target area is hit or not), then the game computing device records a 2 for the ball. In a different scoring example, where the first and second target areas are separate and require equal levels of accuracy and/or skill, hitting either area could award 1 point.

FIG. 15 is a logic diagram of an example of a method for determining bonus points for a round of 5 Drive Golf™. After a round has ended, the method continues with step 398 where a game computing device determines whether all 5 balls of the round were hit on grid by a player. When all 5 balls of the round were hit on grid by the player, the method continues with step 400 where the game computing device records a 2-point bonus for hitting all balls on-grid.

When all 5 balls of the round were not hit on grid by the player or after the game computing device records the 2-point bonus for hitting all balls on-grid, the method continues with step 402 where the game computing device determines whether the player hit the longest ball on the grid.

When the player hit the longest ball on the grid, the method continues with step 404 where the game computing device records a 4-point bonus. When the player did not hit the longest ball on the grid, the method continues with step 406 where the game computing device records no bonus points. Different types of per round bonuses are possible and the different amounts of bonus points could be awarded.

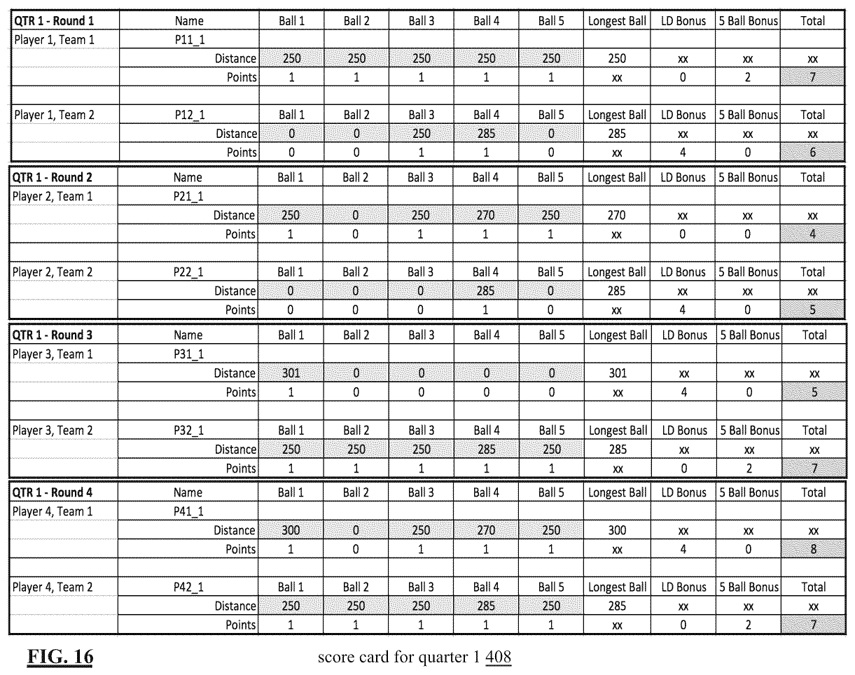

FIGS. 16-19 are diagrams of an example of a 5 Drive Golf™ score card. A score card may be automatically generated by a game computing device when a game computing device is associated with both teams. In another embodiment, a score card is generated by a recreational organization computing device (e.g., a league computing device). For example, the game computing devices communicate game information after each game to the recreational organization computing device.

FIG. 16 depicts a score card for a quarter 1 408 of a game of 5 Drive Golf™ where a quarter consists of four rounds. In this example, each team has four players. The game computing device received the team lineups, generated the lineup scheme for each round of each quarter, and recorded the information from each round. The lineup schemes discussed with reference to FIGS. 11 and 12 may be used to determine which players go head to head each round. Other scrambling schemes can be used to match up the players for each round. The information is sent to the recreational organization computing device to generate a score card.

The player names indicate the player's team, the player's position, and the current quarter. On Team 1, player 1's name is P11_1, player 2's name is P21_1, player 3's name is P31_1, and player 4's name is P41_1. On Team 2, player 1's name is P12_1, player 2's name is P22_1, player 3's name is P32_1, and player 4's name is P42_1.

In a first round, player 1 from Team 1 goes against player 1 from Team 2. In a second round, player 2 from Team 1 goes against player 2 from Team 2. In a third round, player 3 from Team 1 goes against player 3 from Team 2. In a fourth round, player 4 from Team 1 goes against player 4 from Team 2. A distance is recorded for each ball hit or a zero is recorded when a ball is not on grid or is not in play (e.g., the ball has not been hit within a time frame). For every ball on grid, a point is recorded. The score card lists the longest drive the player hit during a round to compare against their opponent. The score card indicates which player received the longest drive bonus (“LD” bonus) in the round and whether the player qualified for a 5 ball bonus (e.g., all five balls were hit on grid in the round). The score card then includes the total points scored by each player in each round.

For example, in round 1, player 1 from Team 1 hit all 5 balls on grid and hit all five balls at a distance of 250 yards. Player 1 from Team 1 receives 5 points for hitting 5 balls on grid. Player 1 from Team's longest drive was 250 yards which did not beat player 1 from Team 2's longest drive of 285 yards. Thus, player 1 from Team 1 does not receive the longest drive bonus. Player 1 from Team 1 receives the 5 ball bonus of 2 points for hitting all 5 balls on grid. Therefore, player 1 from Team 1's total score from round 1 is 7 (5 points for each ball on grid plus 2 points for the 5 ball bonus).

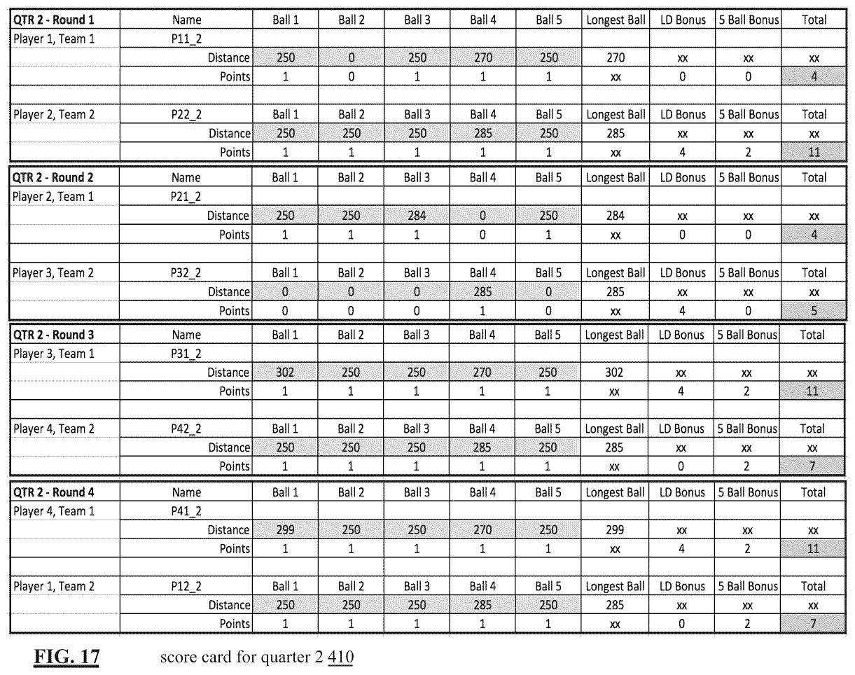

FIG. 17 depicts a score card for a quarter 2 410 of the game of 5 Drive Golf™. The player names are adjusted to indicate the current quarter. In a first round, player 1 from Team 1 goes against player 2 from Team 2. In a second round, player 2 from Team 1 goes against player 3 from Team 2. In a third round, player 3 from Team 1 goes against player 4 from Team 2. In a fourth round, player 4 from Team 1 goes against player 1 from Team 2.

A distance is recorded for each ball hit or a zero is recorded when a ball is not on grid or is not in play (e.g., the ball has not been hit within a time frame). For every ball on grid, a point is recorded. The score card lists the longest drive the player hit during a round to compare against their opponent. The score card indicates which player received the longest drive bonus (“LD” bonus) in the round and whether the player qualified for a 5 ball bonus (e.g., all five balls were hit on grid in the round). The score card then includes the total points scored by each player in each round.

For example, in round 1, player 2 from Team 2 hit all 5 balls on grid where the first, second, third, and fifth balls were hit at 250 yards and a fourth ball was hit at 285 yards. Player 2 from Team 2 receives 5 points for hitting 5 balls on grid. Player 2 from Team 2's longest drive was 285 yards which beats player 1 from Team 1's longest drive of 250 yards. Thus, player 2 from Team 2 receives the longest drive bonus of 4 points. Player 2 from Team 2 receives the 5 ball bonus of 2 points for hitting all 5 balls on grid. Player 2 from Team 2's total score from round 1 is 11 (5 points for each ball on grid plus 4 points for the longest drive plus 2 points for the 5 ball bonus).

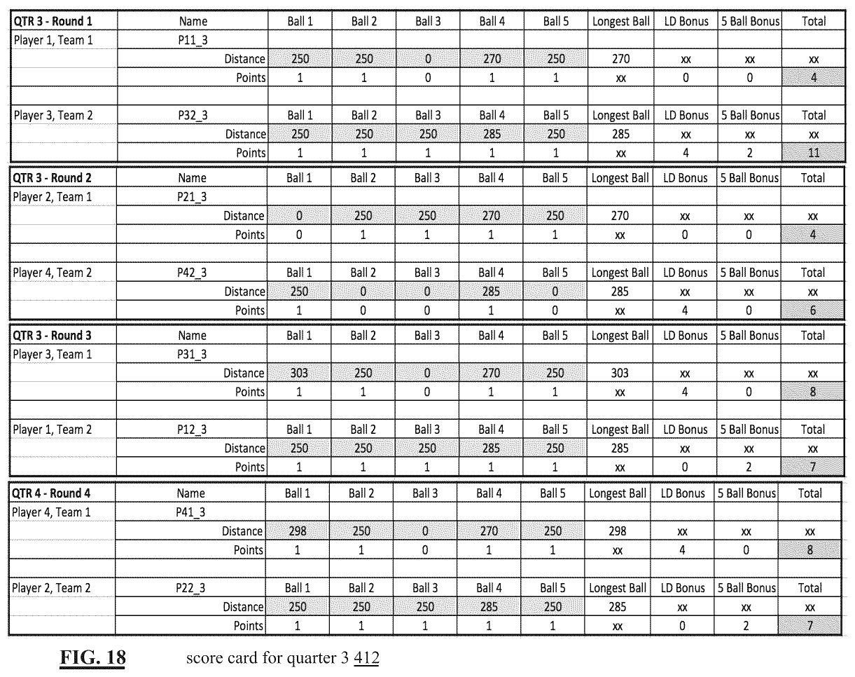

FIG. 18 depicts a score card for a quarter 3 412 of the game of 5 Drive Golf™. The player names are adjusted to indicate the current quarter. In a first round, player 1 from Team 1 goes against player 3 from Team 2. In a second round, player 2 from Team 1 goes against player 4 from Team 2. In a third round, player 3 from Team 1 goes against player 1 from Team 2. In a fourth round, player 4 from Team 1 goes against player 2 from Team 2.

A distance is recorded for each ball hit or a zero is recorded when a ball is not on grid or is not in play (e.g., the ball has not been hit within a time frame). For every ball on grid, a point is recorded. The score card lists the longest drive the player hit during a round to compare against their opponent. The score card indicates which player received the longest drive bonus (“LD” bonus) in the round and whether the player qualified for a 5 ball bonus (e.g., all five balls were hit on grid in the round). The score card then includes the total points scored by each player in each round.

For example, in round 1, player 1 from Team 1 hit 4 out of 5 balls on grid where the first, second, and fifth balls were hit at 250 yards and a fourth ball was hit at 270 yards. Player 1 from Team 1 receives 4 points for hitting 4 balls on grid. Player 1 from Team 1's longest drive was 270 yards which does not beat player 3 from Team 2's longest drive of 285 yards. Thus, player 1 from Team 1 does not receive the longest drive bonus. Player 1 from Team 1 also does not receive the 5 ball bonus of 2 points because ball 3 was hit off grid. Player 1 from Team 1's total score from round 1 is 4 (4 points for each ball on grid).

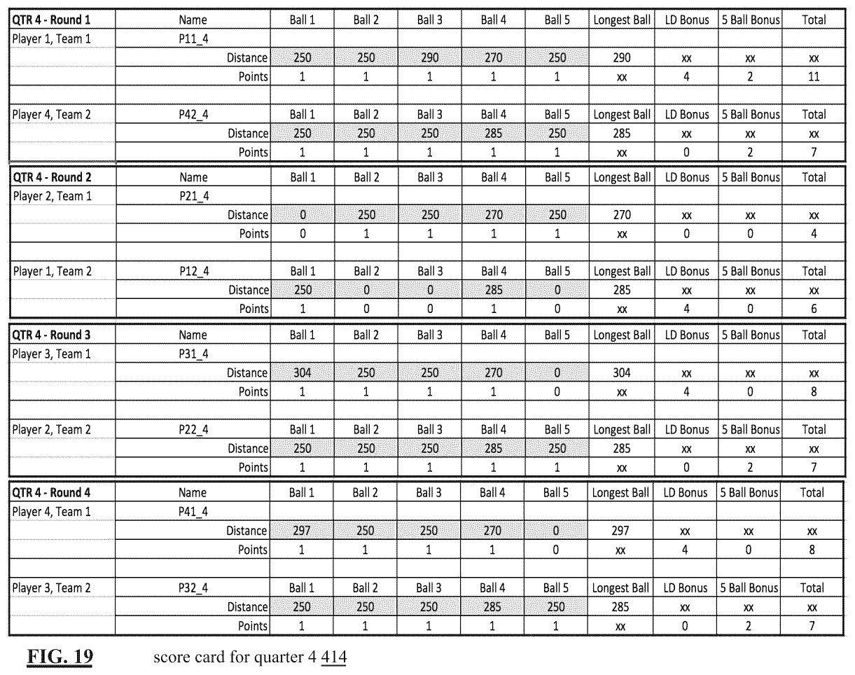

FIG. 19 depicts a score card for a quarter 4 414 of the game of 5 Drive Golf™. The player names are adjusted to indicate the current quarter. In a first round, player 1 from Team 1 goes against player 4 from Team 2. In a second round, player 2 from Team 1 goes against player 1 from Team 2. In a third round, player 3 from Team 1 goes against player 2 from Team 2. In a fourth round, player 4 from Team 1 goes against player 3 from Team 2.

A distance is recorded for each ball hit or a zero is recorded when a ball is not on grid or is not in play (e.g., the ball has not been hit within a time frame). For every ball on grid, a point is recorded. The score card lists the longest drive the player hit during a round to compare against their opponent. The score card indicates which player received the longest drive bonus (“LD” bonus) in the round and whether the player qualified for a 5 ball bonus (e.g., all five balls were hit on grid in the round). The score card then includes the total points scored by each player in each round.

For example, in round 1, player 1 from Team 1 hits all 5 balls on grid where the first, second, and fifth balls were hit at 250 yards, a third ball was hit at 290 yards, and a fourth ball was hit at 270 yards. Player 1 from Team 1 receives 5 points for hitting 4 balls on grid. Player 1 from Team 1's longest drive was 290 yards which beats player 4 from Team 2's longest drive of 285 yards. Thus, player 1 from Team 1 receives the longest drive bonus of 4 points. Player 1 from Team 1 also receives the 5 ball bonus for hitting all 5 balls on grid. Player 1 from Team 1's total score from round 1 is 11 (5 points for each ball on grid plus 4 points for the longest drive bonus plus 2 points for the 5 ball bonus).

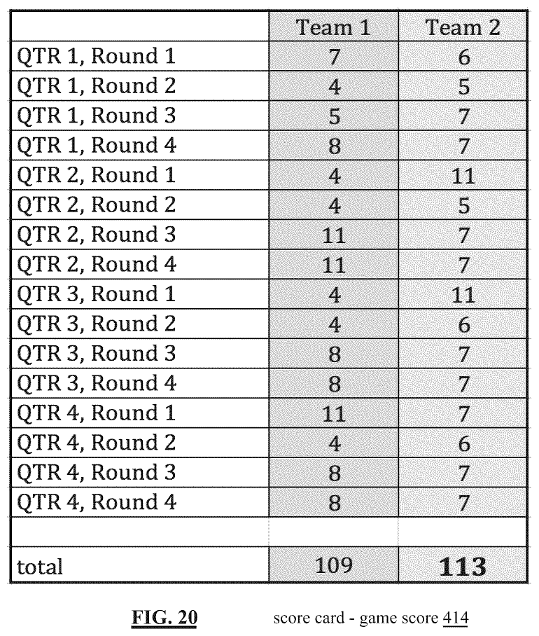

FIG. 20 is a diagram of another example of a 5 Drive Golf™ game score 414. For example, the score card game score 414 is automatically generated by a game computing device after the end of a game of 5 Drive Golf™ when the game computing device is associated with both teams and the game computing device generated the score cards. In another embodiment, a recreational organization computing device generates the score card game score 414 based on the score cards (e.g., where a game computing device communicates the score cards to the recreational organization computing device or the recreational organization computing device generated the score cards).

Using the examples from FIGS. 16-19, the total points from each round of each quarter are totaled to calculate the game score. As shown, Team 1 finished the game with a total of 109 points and Team 2 finished the game with a total of 113 making Team 2 the winner. The score card game score 414 information is communicated to the national organization computing device (e.g., via the game computing device or the recreational organization computing device).

FIG. 21 is a logic diagram of an example of a method for processing a tie-breaker for a game of 5 Drive Golf™. The method begins at step 415 where after step C (e.g., after the end of a regulation game discussed with reference to FIG. 13) the game computing device and/or recreational organization computing device (depending on which device generated the score card game score), determines whether the teams have equal total game points. When the teams do not have equal total game points, the method continues to step E (e.g., the end of the game).

When the teams have equal total game points, the method continues to step 416 where the game computing device and/or the recreational organization computing device records a player “a” of Team 1 for a tie-breaker round and step 418 where the game computing device and/or the recreational organization computing device records a player “b” of Team 2 for the tie-breaker round. The players may be randomly selected, based on a scrambling scheme, or specifically selected by each team. The tie-breaker round information is recorded by a game computing device associated with the player “a” of Team 1 and a game computing device associated with the player “b” of Team 2 where the game computing device associated with the player “a” of Team 1 and the game computing device associated with the player “b” of Team 2 may be the same or different game computing device.

The method continues to step 420 where the game computing device associated with the player “a” records a distance of a ball for player “a” of Team 1 and step 422 where the game computing device associated with the player “b” records a distance of a ball for player “b” of Team 2. The method continues to step 424 where the game computing device associated with the player “a” determines whether a per ball bonus applies for the ball hit by player “a” of Team 1 (e.g., a target was hit) and step 426 where the game computing device associated with the player “b” determines whether a per ball bonus applies for the ball hit by player “b” of Team 2.

When the per ball bonus applies for the ball hit by player “a” of Team 1, the method continues with step 428 where the game computing device associated with the player “a” determines and records the per ball bonus. When the per ball bonus applies for the ball hit by player “b” of Team 2, the method continues with step 430 where the game computing device associated with the player “b” determines and records the per ball bonus.

After the game computing device associated with the player “a” determines and records the per ball bonus for the ball hit by player “a” of Team 1 or when the per ball bonus does not apply for the ball hit by player “a” of Team 1, the method continues with step 432 where the game computing device associated with the player “a” determines and records the points received for the ball. After the game computing device associated with the player “b” determines and records the per ball bonus for the ball hit by player “b” of Team 2 or when the per ball bonus does not apply for the ball hit by player “b” of Team 2, the method continues with step 434 where the game computing device associated with the player “b” determines and records the points received for the ball.

The method continues with steps 436 and 438 where the game computing devices determines whether the round has ended. When the round is not over, the method continues to steps 420 and 422 to record another round between the two players. When the round is over, the method continues with step 440 where the game computing device associated with the player “a” determines and records player “a” of Team 1's bonus points for the round (if any) and with step 442 where the game computing device associated with the player “b” determines and records player “b” of Team 2's bonus points for the round (if any).

The method continues with step 444 where the game computing device associated with the player “a” determines and records player “a” of Team's total points for the round and with step 446 where the game computing device associated with the player “b” determines and records player “b” of Team 2's total points for the round. The round information may then be communicated with the recreational organization computing device to generate the score cards.

The method continues with step 448 where one or more of the game computing device or the recreational organization computing device determines whether there is another tie. When there is a tie, the method continues with step D, where another tiebreaker round is initiated. For example, steps 416-446 repeat with a next player from each team. When there is not a tie, the method continues with step E, where the game ends.

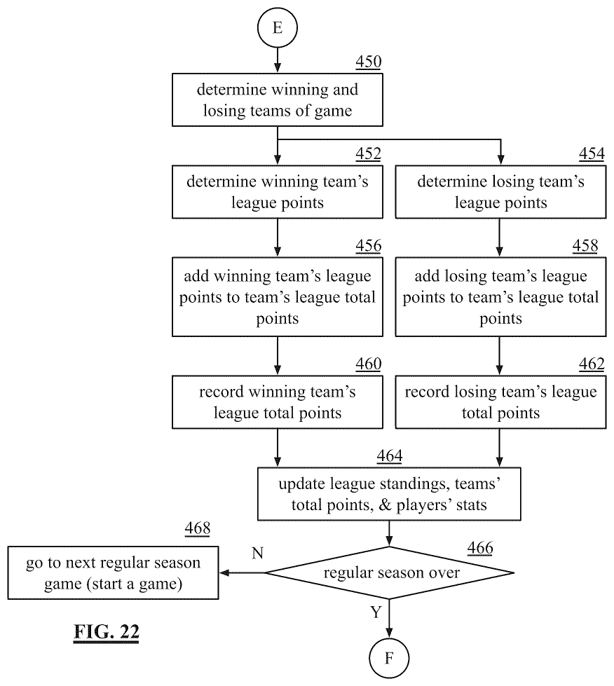

FIG. 22 is a logic diagram of an example of a method for determining a winning team for a game of 5 Drive Golf™ and updating league standings. At step E, where a game ends, the method begins with step 450 where a recreational organization computing device determines winning and losing teams of the game. The method continues with step 452 where recreational organization computing device determine the winning team's league points and step 454 where recreational organization computing device determine the losing team's league points. For example, different league points may be awarded for a standard loss versus a tie breaker loss. As an example, a winning team receives 2 league points, a losing team with a standard loss receives 0 league points, and a losing team with a tie-breaker loss receives 1 league point.

The recreational organization computing device provides the team league points to a national organization computing device. The national organization computing device organizes the leagues and updates the league standings. The method continues with step 456 where the national organization computing device adds the winning team's league points to the team's league total and step 458 where the national organization computing device adds the losing team's league points to the team's league total. The method continues with step 460 where the national organization computing device records the winning team's league total points and step 462 where the national organization computing device records the losing team's league total points.

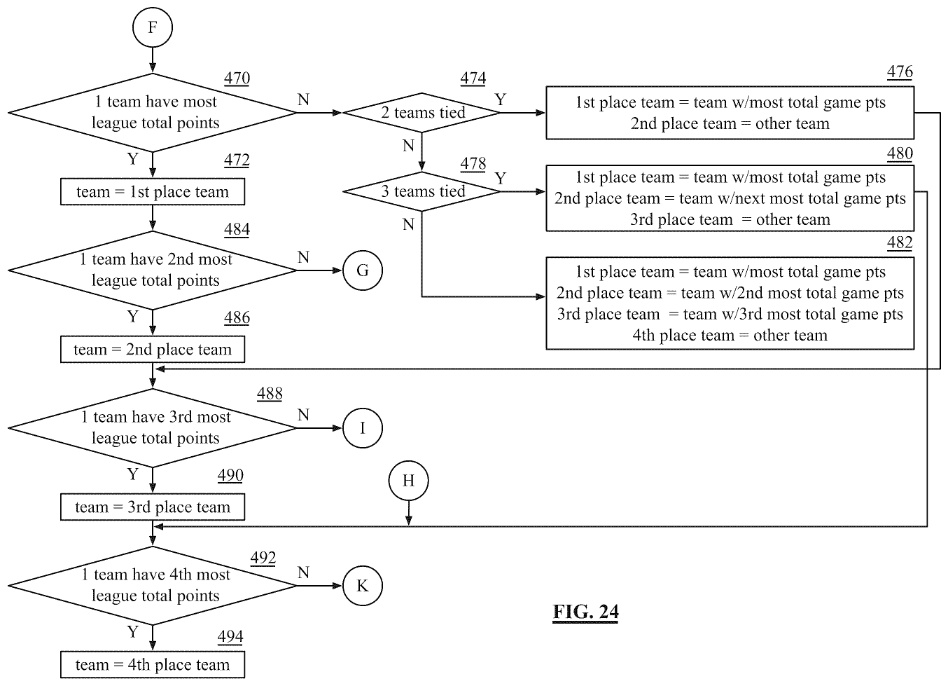

The method continues with step 464 where the national organization computing device updates the league standings, the teams' total league points, and the players' stats based on the game that ended. The method continues with step 466 where the national organization computing device determines whether the regular season is over. When the regular season is over, the method continues to step F where a playoff season begins. The playoff season is discussed in further detail with reference to FIG. 24.

When the regular season is not over, the method continues to step 468 where a next regular season game can begin. For example, the national organization computing device communicates with one or more recreational organization computing devices, one or more game computing devices, one or more team computing devices, and/or one or more player computing devices to the deliver the updated league standings and to notify teams to begin a new game.

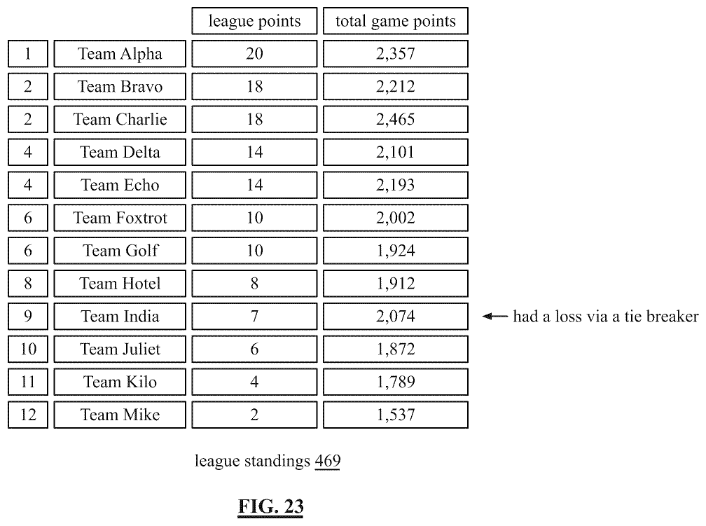

FIG. 23 is a diagram of an example of 5 Drive Golf™ league standings 469 for a particular league. In this example, the league includes 12 teams. A regular season may include 66 games where each team plays 11 games with 132 total points for wins.

The league standings includes a team's league points, a team's total game points, and the team's standing in the league. A team Alpha is in first place with 20 league points, teams Bravo and Charlie are tied in second place with 18 league points, teams Delta and Echo are tied in fourth place with 14 league points, team Foxtrot and Golf are tied in sixth place with 10 league points, a team Hotel is in eighth place with 8 league points, a team India is in ninth place with 7 league points (an odd number of points due to a loss via a tie breaker), a team Juliet is in tenth place with 6 league points, a team Kilo is in eleventh place with 4 league points, and a team Mike is in twelfth place with 2 league points.

FIGS. 24-26 are a logic diagram of an example of a method for determining playoff teams for a 5 Drive Golf™ League. FIG. 24 begins at step F where a regular season has ended. The top four teams from the regular season will make a single elimination playoff. The method continues with step 470 where the national organization computing device determines whether one team has the most league total points. When one team has the most league total points, the method continues with step 472 where the team with the most league total points is the first place team. For example, in FIG. 23, Team Alpha has the most league total points at 20 league total points making Team Alpha the first place team.

When one team does not have the most league total points, the method continues with step 474 where the national organization computing device determines whether two teams are tied. When two teams are tied, the method continues with step 476 where the national organization computing device determines that the first place team is the team with the most game points and the second place team is the other team. The method continues to step 488 where the national organization computing device determines whether one team has the third most league total points.

When two teams are not tied, the method continues with step 478 where the national organization computing device determines whether three teams are tied. When three teams are tied, the method continues with step 480 where the national organization computing device determines that the first place team is the team with the most game points, the second place team is the team with the second most game points, and the third place team is the other team. The method continues with step 492 where the national organization computing device determines whether one team has the fourth most league total points.

When three teams are not tied (e.g., four teams are tied), the method continues with step 482 where the national organization computing device determines that the first place team is the team with the most game points, the second place team is the team with the second most game points, the third place team is the team with the third most game points, and the fourth place team is the other team.

When one team has the most league total points and that team is put in first place at step 472, the method continues with step 484 where the national organization computing device determines whether one team has the second most league total points. When one team has the second most league total points, the method continues with step 486 where the team with the second most league total points is the second place team.

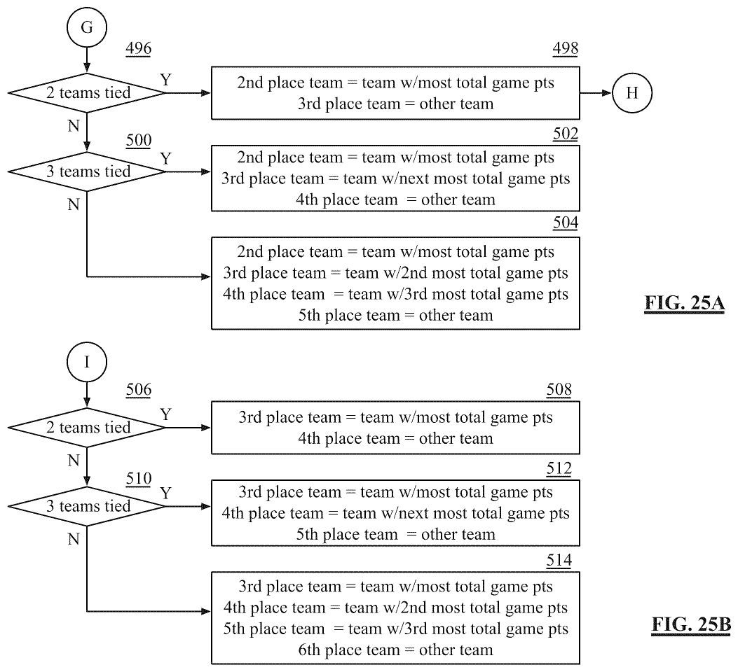

When one team does not have the second most league total points, the method continues with step G which is discussed with reference to FIG. 25A. When one team has the second most league total points and that team is put in second place at step 486 or the first two teams are decided in step 476, the method continues with step 488 where the national organization computing device determines whether one team has the third most league total points. When one team has the third most league total points, the method continues with step 490 where the team with the third most league total points is the third place team.

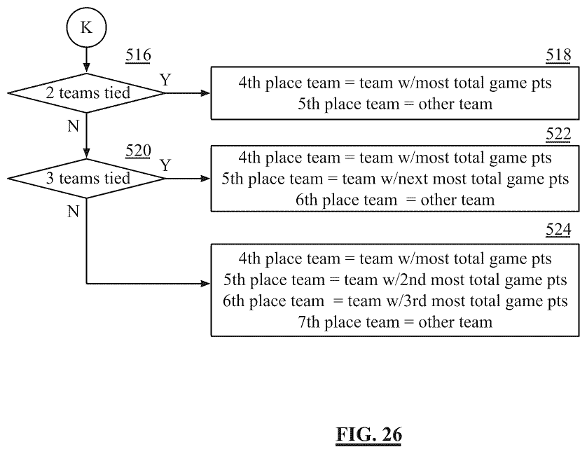

When one team does not have the third most league total points, the method continues with step I which is discussed with reference to FIG. 25B. When one team has the third most league total points and that team is put in third place at step 490, the three teams are decided in step 480, or the second and third teams are determined from step H (e.g., of FIG. 25A), the method continues with step 492 where the national organization computing device determines whether one team has the fourth most league total points. When one team has the fourth most league total points, the method continues with step 494 where the team with the fourth most league total points is the fourth place team. When one team does not have the fourth most league total points, the method continues with step K which is discussed with reference to FIG. 26.

FIG. 25A begins with step of G of FIG. 24 when one team does not have the second most league total points. The method continues with step 496 where the national organization computing device determines whether two teams are tied. When two teams are tied, the method continues with step 498 where the national organization computing device determines that the second place team is the team with the most game points and the third place team is the other team. The method continues with step H of FIG. 24 which continues to step 492 where the national organization computing device determines whether one team has the fourth most league total points.

When two teams are not tied, the method continues with step 500 where the national organization computing device determines whether three teams are tied. When three teams are tied, the method continues with step 502 where the national organization computing device determines that the second place team is the team with the most game points, the third place team is the team with the next most game points, and the fourth place team is the other team.

When three teams are not tied (e.g., four teams are tied), the method continues with step 504 where the national organization computing device determines that the second place team is the team with the most game points, the third place team is the team with the second most game points, the fourth place team is the team with the third most game points, and the fifth place team is the other team.

FIG. 25B begins with step of I of FIG. 24 when one team does not have the third most league total points. The method continues with step 506 where the national organization computing device determines whether two teams are tied. When two teams are tied, the method continues with step 508 where the national organization computing device determines that the third place team is the team with the most game points and the fourth place team is the other team.

When two teams are not tied, the method continues with step 510 where the national organization computing device determines whether three teams are tied. When three teams are tied, the method continues with step 512 where the national organization computing device determines that the third place team is the team with the most game points, the fourth place team is the team with the next most game points, and the fifth place team is the other team.

When three teams are not tied (e.g., four teams are tied), the method continues with step 514 where the national organization computing device determines that the third place team is the team with the most game points, the fourth place team is the team with the second most game points, the fifth place team is the team with the third most game points, and the sixth place team is the other team.

FIG. 26 begins with step of K of FIG. 24 when one team does not have the fourth most league total points. The method continues with step 516 where the recreational organization computing device determines whether two teams are tied. When two teams are tied, the method continues with step 518 where the national organization computing device determines that the fourth place team is the team with the most game points and the fifth place team is the other team.

When two teams are not tied, the method continues with step 520 where the national organization computing device determines whether three teams are tied. When three teams are tied, the method continues with step 522 where the national organization computing device determines that the fourth place team is the team with the most game points, the fifth place team is the team with the next most game points, and the sixth place team is the other team.

When three teams are not tied (e.g., four teams are tied), the method continues with step 524 where the national organization computing device determines that the fourth place team is the team with the most game points, the fifth place team is the team with the second most game points, the sixth place team is the team with the third most game points, and the seventh place team is the other team.

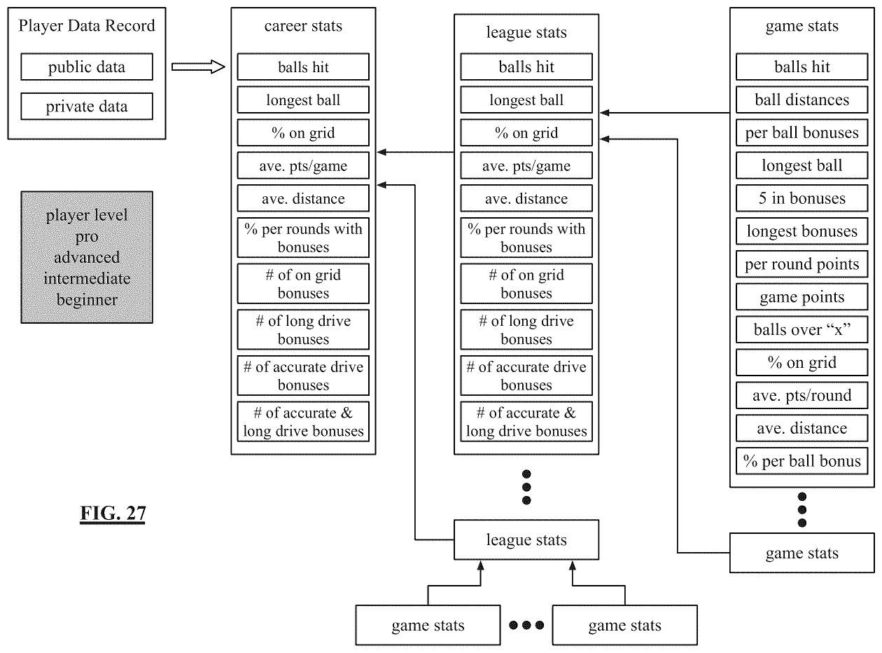

FIG. 27 is a diagram of an example of updating a player's statistics. The player's stats can be on a per game basis, on a league basis, and/or on a career basis. The player's stats include one or more of, but is not limited to, number of balls hit, longest ball hit, balls on grid percentage, average points per game, average driving distance, percentage of rounds with a bonus, number of on-grid bonuses, number of long drive bonuses, number of accurate drive bonuses, number of accurate and long drive bonuses, percentage of on-grid bonuses, percentage of long drive bonuses, percentage of accurate drive bonuses, percentage of accurate and long drive bonuses, number of balls in accurate zone, number of balls in super accurate zone, number of balls over long drive marker, number of balls over super long drive marker, number of balls accurate and long, number of balls accurate and super long, number of balls super accurate and long, number of balls super accurate and super long, percentage of balls in accurate zone, percentage of balls in super accurate zone, percentage of balls over long drive marker, percentage of balls over super long drive marker, percentage of balls accurate and long, percentage of balls accurate and super long, percentage of balls super accurate and long, percentage of balls super accurate and super long, etc.

In this example, game stats feed league stats, which feed career stats for a player. Each level of stats can be viewed.

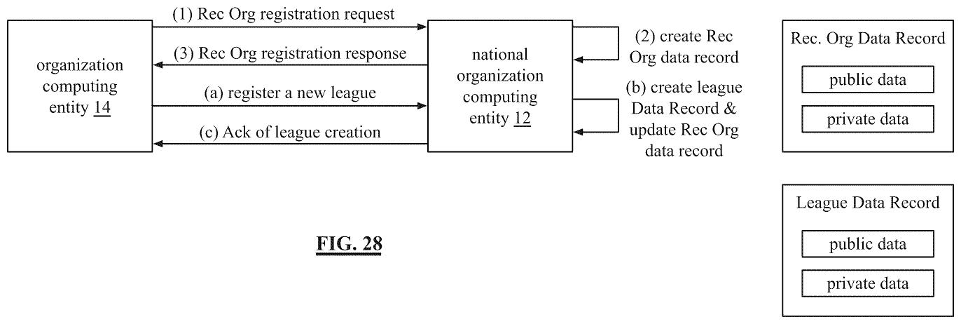

FIG. 28 is a diagram of an example of creating a 5 Drive Golf™ League. The process begins with an organization computing entity 14 sending a request to a national organization computing entity 12 to become a registered organization of 5Drive. The request includes information regarding the organization affiliated with the organization computing entity 14. The information includes an organization name, address, email, phone number, contact person, etc.

The national organization computing entity 12 processes the request. If approved, the national organization computing entity creates an organization record for the organization, which includes public data and private data. The public data includes organization's name, contact information, leagues it hosts, addresses, and other data of a non-sensitive nature. The private data includes the organization's ID, league conduct data, player conduct data, team conduct data, financial information, and other data of a sensitive nature.

The national computing entity 12 sends a response to the organization computing entity 14. If the response is favorable, the organization computing entity can register one or more leagues. A league is certain type of play and/or players. For example, a league may be a competitive recreational league, a men's league, a women's league, a mixed league, etc. A league may last in perpetuity and may include one or more seasons per year. A season is for a set period of time for a specified number of teams.

To register a league, the organization computing entity sends a new league request to the national organization computing entity 12. The national organization computing entity 12 reviews the organization's data (private and public) to determine if the league should be created. For example, if the organization is on probation for a conduct issue, the request to create a league may be denied.

If the request to create a league is approved, the national organization computing entity 12 creates a record for the league, which includes league public data and league private data. The national organization computing entity 12 provides a response to the organization computing entity. If it is a favorable response, the organization computing entity 16 can start organizing seasons and signing up teams to play.

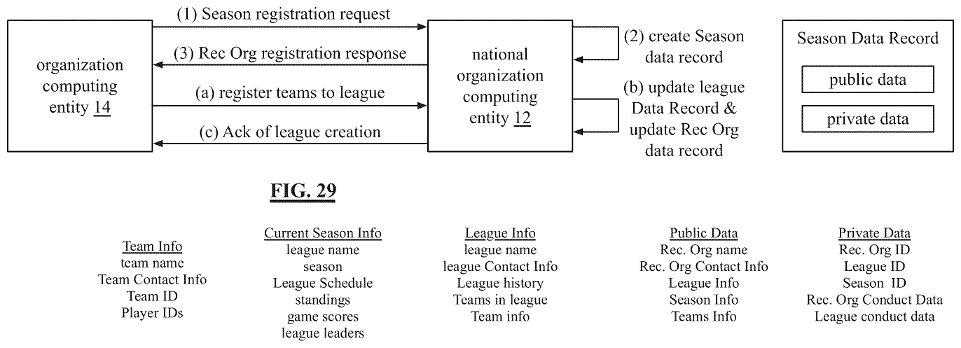

FIG. 29 is a diagram of an example of an organization computing entity registering a season of a 5 Drive Golf™ League with a national organization computing entity. The organization computing entity sends a request to start a season of a league to the national organization computing entity 12. If the league and organization are in good standing, the national organization computing entity grants the request and creates a season data record for storing season private data and season public data.

After receiving a favorable response to the season creation request, the organization computing entity registers teams with the national organization computing entity 12. The national organization computing entity updates the season record with the team's information. During the season, the national organization computing entity updates the season's record with data from the games, league standings, playoffs, and other data regarding the league, the teams in the league, and/or the players on the teams.

Assuming the teams and its players are in good standing, the national organization computing entity accepts the registration of the teams and their players. The national organization computing entity then sends an acknowledgement to the organization computing entity.

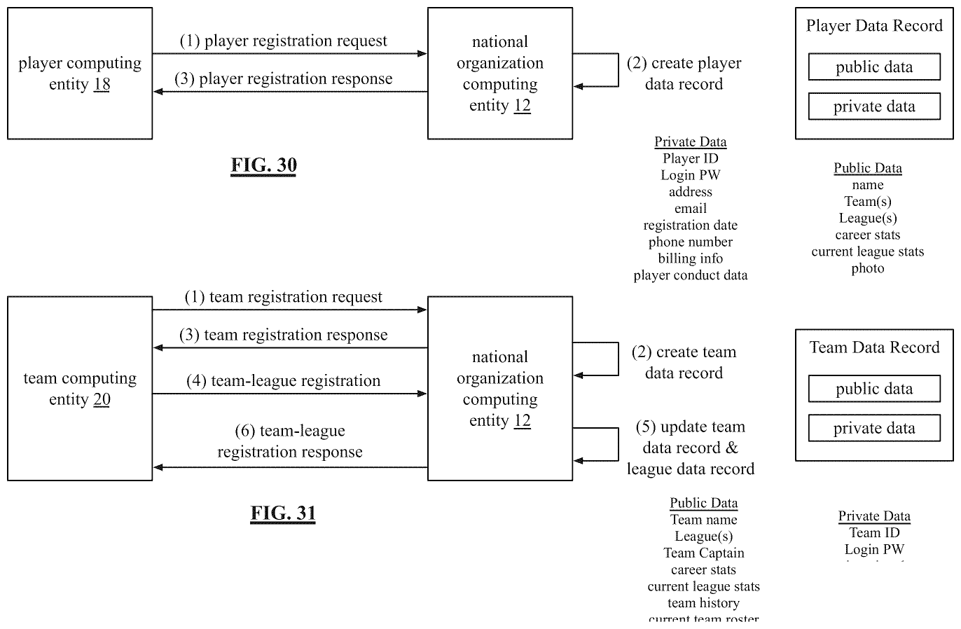

FIG. 30 is a diagram of an example of a player computing entity registering a player with a national organization computing entity. The player computing entity sends a request to join the national 5Drive organization to the national organization computing entity 12. If the national organization computing entity verifies the player associated with the player computing entity and the player is in good standing, the national organization computing entity grants the request and creates a player data record for storing player private data and player public data. Examples of each are shown.

FIG. 31 is a diagram of an example of a team computing entity registering a team with a national organization computing entity and joining a 5 Drive Golf™ League. The team computing entity, which could be a player's computing entity of a player who is running the team, sends a request to join the national 5Drive organization to the national organization computing entity 12. If the national organization computing entity verifies the team associated with the team computing entity and the players of the team, and the team and its players are in good standing, the national organization computing entity grants the request and creates a team data record for storing team private data and team public data. Examples of each are shown.

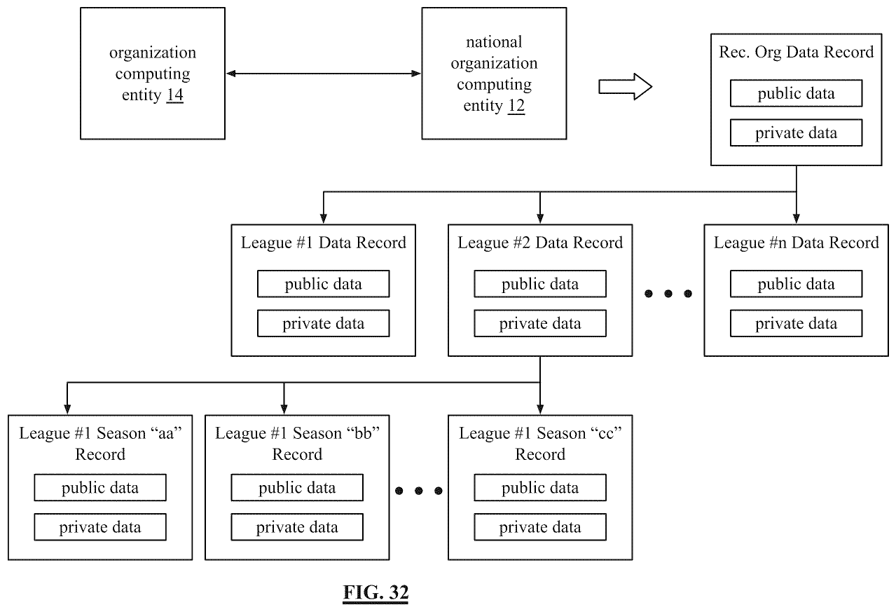

FIG. 32 is a diagram of an example of a national organization computing entity creating a plurality of league data records for an organization. In this example, the organization's data record is linked to each of its leagues data records. Each league data record is linked to its season data records.

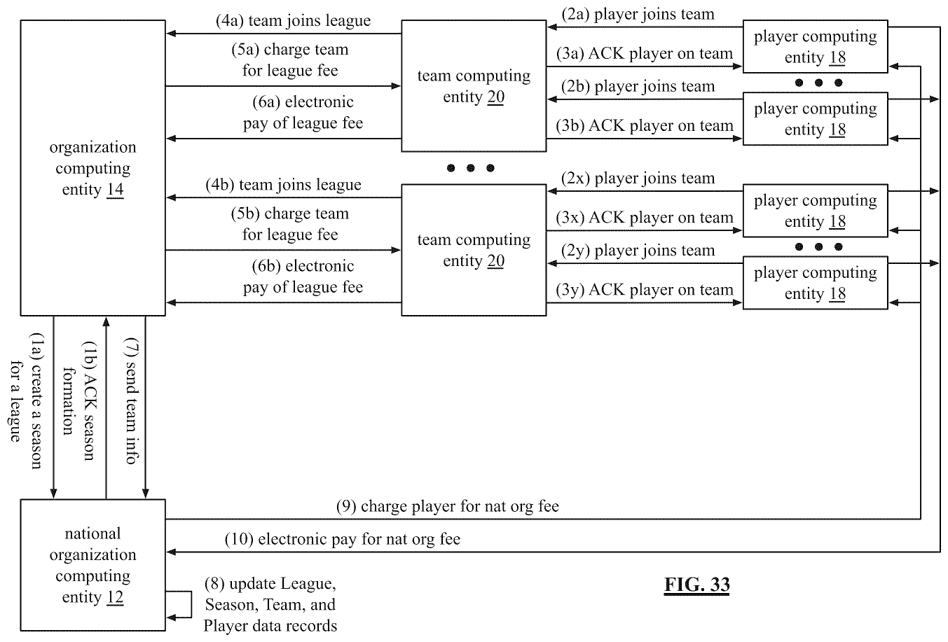

FIG. 33 is a diagram of an example of a national organization computing entity registering teams and players for a season of a 5 Drive Golf™ League. In this example, a team registers with an organization to join a league and to participate in one or more seasons. Prior to joining a league for a given season, a team registers its players via the team computing entity interfacing with the player computing entities.

Each team is charged a fee to participate in a season of a league by the organization. Payment is handled electronically between the team computing entity and the organization computing entity. Players' portion of the team fee is electronically handled between the team computing entity and the player computing entity.

After a team is registered for a season of a league, the organization computing entity 14 sends a notice to the national organization computing entity 12. If the team and its players are in good standing and are registered with the national organization, the national organization computing entity provides a team acknowledgement to the organization computing entity. After all teams of a season have been verified by the national organization computing entity, the organization computing entity is ready to host the season.

To collect a national fee from each player, the national organization computing entity 12 sends a payment request to a player's computing entity. The payment is handled electronically. The player national organization fee may be an annual fee, a one-time fee, or a fee per season-per league that the player is registered.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A computing system comprises:
a game computing entity that includes a first network interface module, a first processing module, a first video processing module, and a first display; and
a plurality of participant computing entities, wherein a participant computing entity of the plurality of participant entities includes a second network interface module, a second processing module, a second video processing module, and a second display;
wherein the first processing module is operable to:
communicate, via the first network interface, with the with participant computing entity data to obtain player data that includes one or more of a player's skill level and a player's strength level;
setup a golf accuracy and distance game between two or more players based on respective player data, wherein the setup includes:
creating a digital representation of a first golf grid for a first participant based on the player data associated with the first participant; and
creating a digital representation of a second golf grid for a second participant based on the player data associated with the second participant;
monitor game play by:
provide the digital representation of the first golf grid to the first display via the first video processing module for display;
obtain digital coordinates corresponding to a position of a struck golf ball;
correlate the digital coordinates to a digital coordinate system of the first golf grid to determine the position of the struck golf ball with respect to the first golf grid;
when the position is within the digital coordinates of the first golf grid:
determine an accuracy distance of the position with respect to a digital representation of a center reference indicator;
determine a length distance of the position with respect to a digital representation of a long drive marker; and
generate a score for the struck golf ball based on the accuracy distance and the length distance.

2. The computing system of claim 1, wherein the participant computing entities comprises at least one of:
a team computing entity; and
a player computing entity.

3. The computing system of claim 1, wherein the first processing module is further operable to monitor game play by:
providing the digital representation of the second golf grid to the first display via the first video processing module for display;
obtain second digital coordinates corresponding to a second position of a second struck golf ball;
correlate the second digital coordinates to a digital coordinate system of the second golf grid to determine the position of the second struck golf ball with respect to the second golf grid;
when the position of the second struck golf ball is within the digital coordinates of the second golf grid:
determine a second accuracy distance of the second position with respect to a digital representation of a second center reference indicator of the second golf grid;
determine a second length distance of the second position with respect to a digital representation of a second long drive marker of the second golf grid; and
generate a second score for the second struck golf ball based on the second accuracy distance and the second length distance.

4. The computing system of claim 1 further comprises:
the first processing module is further operable to:
communicate, via the first network interface, the digital representation of the first golf grid to a first participant computing entity of the plurality of participate computing entities;
the first participant computing entity is further operable to:
display, via the second video processing module and the second display of the first participant computing entity, the digital representation of the first golf grid; and
display, via the second video processing module and the second display of the first participant computing entity, the score.

5. The computing system of claim 1 further comprises:
the first processing module is further operable to:
communicate, via the first network interface, the digital representation of the first golf grid to a second participant computing entity of the plurality of participate computing entities;
the second participant computing entity is further operable to:
display, via the second video processing module and the second display of the second participant computing entity, the digital representation of the first golf grid; and
display, via the second video processing module and the second display of the second participant computing entity, the score.

6. The computing system of claim 1 further comprises:
the first processing module is further operable to:
generating a digital representation of the struck golf ball;
providing the digital representation of the struck golf ball and the digital representation of the first golf grid to the first video graphics processing module;
the first video graphics processing module is further operable to:
generate video data based on the digital representation of the struck golf ball and the digital representation of the first golf grid; and
provide the video data to the first display for display.

7. The computing system of claim 1 further comprises:
the first processing module is further operable to:
communicate, via the first network interface, the video data to a first participant computing entity of the plurality of participant computing entities; and
communicate, via the first network interface, the video data to a second participant computing entity of the plurality of participant computing entities.
